(19) United States
(12) Patent Application Publication
(10) Pub. No.: US 2011/0076377 A1
(43) Pub. Date: Mar. 31, 2011

(54) ETHOID COMPOUNDS FOR USE AS FOOD ADDITIVES

(75) Inventor: Hendrik Mario Geysen, Charlottesville, VA (US)

(73) Assignee: UNIVERSITY OF VIRGINIA PATENT FOUNDATION, Charlottesville, VA (US)

(21) Appl. No.: 12/744,735

(22) PCT Filed: Nov. 26, 2008
(86) PCT No.: PCT/US08/84776

§ 371 Date: May 26, 2010

Related U.S. Application Data
(60) Provisional application No. 60/990,783, filed on Nov. 28, 2007.
(60) Provisional application No. 61/127,684, filed on May 14, 2008.

(51) Int. Cl. A23L 1/236

(52) U.S. Cl. 426/548

(57) ABSTRACT

Provided herein are food products, ingredients, beverages, and the like, comprising a peptide analog that contains one or more ethoid bonds, along with methods for preparing such peptide analogs, related compositions, and the ethoid peptide analogs themselves. The ethoid compounds described are useful as food ingredients, such as sweeteners, flavor enhancers and taste-modifying agents.

### CROSS-REFERENCE TO RELATED APPLICATIONS

This application is entitled to priority pursuant to 35 U.S.C. §119(e) to U.S. provisional patent application No. 60/990,783, filed on Nov. 28, 2007 and U.S. provisional patent application No. 61/127,684, filed on May 14, 2008. The entire disclosures of the afore-mentioned patent applications are incorporated herein by reference.

### FIELD

The present disclosure is directed to peptide analogs having at least one ethoid bond, food and pharmaceutical products, among others, comprising such peptide analogs, related compositions, and methods for making and using such ethoid-comprising peptide analogs, among other features.

### BACKGROUND

The food and beverage industry continuously searches for new and better products to improve the flavor, taste, stability and safety of food ingredients, while still providing a product that consumers will consider healthy. There exists a constant and ongoing search for artificial sweeteners or flavoring agents, particularly as an alternative to the higher calorie natural sweetener, sugar (or sucrose). As an indication, sales of artificial sweeteners totaled 1.6 billion dollars in 2006. The use of sweeteners has become widespread in a wide array of food products, and in particular, in prepared foods. Moreover, the availability of convenience-based foods has increased the consumption of sweeteners and sweetened foods, leading to an increased calorie consumption and a notable rise in obesity in the United States. Attempts to reduce the caloric content of foods without sacrificing sweetness or taste have led to a high demand for reduced calorie foods that are sweetened with artificial sweeteners.

In spite of their low caloric content, artificial sweeteners can elicit certain undesirable side effects. For example, although saccharin is significantly (i.e., 300-450 times) sweeter than sugar, its use is often associated with complaints regarding its bitter and metallic aftertaste. Newer artificial sweeteners, such as aspartame and neotame, exhibit sweet taste profiles that lack bitter or off-flavor aftertastes. Aspartame (L-aspartyl-L-phenylalanine methyl ester) is 150-fold sweeter than an equivalent amount of sugar. Neotame (an N-alkylated derivative of aspartame, N-[N-(3,3-dimethylbutyl)-L-α-aspartyl]-L-phenylalanine) is approximately 8,000 times sweeter than sugar. Both compounds are dipeptides of aspartic acid and phenylalanine.

Unfortunately, these more recently developed sweeteners, aspartame and neotame, each possess other associated drawbacks. For instance, aspartame decomposes upon heating, and therefore is typically not used in foods that require baking or cooking. Additionally, aspartame is unstable under acidic conditions when exposed to elevated temperatures—which presents a concern for its use in carbonated soft drinks. Further, the hydrolysis of the peptide bonds and the methyl ester on phenylalanine can lead to loss of sweetness and also allow for other molecular interactions. For example, condensation reactions have been reported at elevated temperatures, while interactions with glucose and vanillin under alkaline conditions have been reported. Such interactions render aspartame incompatible with certain food constituents. Products resulting from the degradation of aspartame also prohibit its consumption for individuals with phenylketonuria, since phenylalanine is one of aspartame's associated degradation products. Neotame, while having certain advantages over aspartame, e.g., its stability at elevated temperatures—lending to its ability to be used in baked goods and those requiring applications of heat, and its improved stability at neutral pHs in solution in comparison to aspartame, still possesses certain disadvantages. For instance, in aqueous food systems, neotame possesses the same drawbacks as aspartame when in acidic media, but is significantly more stable than aspartame in neutral media. Moreover, as in the case of aspartame, one of the undesirable degradation products of neotame is methanol. Finally, the taste profile of artificial sweeteners does not match the profile of sucrose.

In view of the foregoing, there still exists a need for sweeteners containing fewer calories than sugar, but having a sweetness at least equal to, and preferably several-fold improved over sugar. Ideally, such sweeteners will also have improved stability profiles when compared to artificial sweeteners such as aspartame.

### SUMMARY

The present invention provides compounds, and in particular, peptides having at least one ethoid bond. Such compounds are referred to herein generally as ethoid compounds. Surprisingly, it has been discovered that the compounds provided herein possess the feature of “sweetness”, and can be used as sweetening agents in a number food, pharmaceutical, and other applications. For instance, the present ethoid compounds can be used as food ingredients, such as sweeteners, flavor enhancers, flavoring agents, taste-modifying agents and the like, in an assortment of food and beverage products.

Generally, the peptide analogs of the invention comprise one or more ethoid (or ether) bonds, where the ether bond is an isosteric replacement for one or more amide bonds in a parent peptide. Generally, the compounds of the invention are oligopeptides, comprising from two to about 40 amino acids, and comprise at least one ethoid isostere (as a substitutive replacement for an amide moiety thereof). For instance, in an illustrative ethoid dipeptide analog, the amide bond in the parent dipeptide (_{N-terminal} . . . C(O)—NH— . . . _{COOH terminal}) is replaced by an ether bond, —(HC—R₁₀)₁₋₃—O—), where R₁₀ is generally hydrogen, halogen, hydroxyl, C1-C3 alkyl or substituted alkyl. In a preferred embodiment, R₁₀ is hydrogen, such that the ethoid isostere is —(CH₂)_{1,2,3}—O—. Typically, the ethoid isostere is —CH₂—O—, such that one or more amide bonds in a parent peptide, e.g., an oligopeptide, is replaced with —CH₂—O—. Preferably, the ethoid compound can comprise an ethoid mimetic residue having a substituted carbon atom adjacent to the methyleneoxy, e.g., —CH(Rₓ)CH₂O—, where the Rₓ side-chain can correspond to the structure of a side-chain moiety pendant from an alpha carbon of an amino acid. The present invention is directed in various aspects and embodiments to certain ethoid compounds, compositions (including food products or compositions, pharmaceutical compositions such as oral pharmaceuticals, and the like) comprising such ethoid compounds, methods for preparing such compounds, and methods for using such compounds.

In a first aspect, the invention is directed to a food product comprising a food ingredient, where the food ingredient is a sweetening agent comprising a peptide analog having at least one ethoid bond. In one embodiment, the food ingredient comprises a compound of Formula I-C,

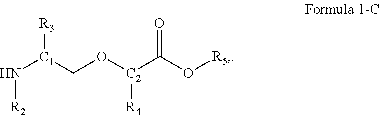

As can be seen from the foregoing formula, the compound possesses the general structure of a dipeptide analog, where the amide bond is replaced by a methyleneoxy bond. Generally, illustrative substituents (R₂, R₃, R₄ and R₅) are each independently selected from the group consisting of hydrogen, alkyl, cycloalkyl, alkylene-cycloalkyl, alkyl-substituted cycloalkyl, aryl, alkylene-aryl, alkyl-substituted aryl, and acyl, each of the foregoing being optionally substituted with or one or more of halogen, hydroxyl, heteroatom, or heteroatom-containing groups, such heteroatom being selected from N and O.

In one or more general preferred embodiments, R₂ and R₅, may each be independently selected from hydrogen, alkyl, cycloalkyl, aryl, alkyl-substituted cycloalkyl, alkyl-substituted aryl, and acyl.

In one sub-embodiment of the foregoing, R₂ is selected from hydrogen, linear or branched alkyl, cycloalkyl, alkyl-substituted cycloalkyl, alkyl-substituted aryl, or acyl. Preferably, such linear or branched alkyl is C1-C8 alkyl while such cycloalkyl is C3-C8 cycloalkyl. In yet another sub-embodiment, such C1-C8 alkyl is selected from CH₃(CH₂)₂CH₂—, (CH₃)₂CHCH₂—, (CH₃)₂CHCH₂CH₂—, CH₃CH₂CH(CH₃)CH₂—, (CH₃CH₂)₂CHCH₂—, and (CH₃)₃CCH₂CH₂—. Exemplary acyl substituents include —C(O)—R, where R is selected from methyl, ethyl, propyl, butyl, pentyl, and the like.

In yet another sub-embodiment of the foregoing structure (Formula 1-C), R₃, the substituent on C1 (alpha to the amino nitrogen), is selected from —(CH₂)ₙC(O)OR₆, and —X—(CH₂)ₙ—C₆H₄R₇, where R₆ is independently selected from hydrogen, methyl, ethyl, propyl and butyl, R₇ is independently selected from hydrogen, methyl, ethyl, propyl, butyl, and hydroxyl, where R₇ may be in an ortho, meta or para position on a phenyl ring, each n is independently an integer from 1-4, and X is O, —NH, or S. A preferred R₃ group, in one or more embodiments, is —

CH₂COOR₆, or even more preferably, —CH₂COOH.

In a further sub-embodiment of the foregoing, R₄ encompasses N-substituted amides. Particular R₄ groups include —(CH₂)ₙC₆H₄R₇ and —(CH₂)ₙ—C5-C7 cycloalkyl, where the cycloalkyl is optionally substituted with one or more heteroatom-containing groups, and —C(O)NHR₈, where R₇ is selected from hydrogen, methyl, ethyl, propyl, butyl, and hydroxyl, and may be in an ortho, meta or para position, n is independently an integer from 1-4, and R₈ is selected from alkyl, cycloalkyl, alkylene-cycloalkyl, alkylene-aryl, each of the foregoing being optionally substituted with or one or more heteroatoms, or heteroatom-containing groups, such as nitrogen, sulfur, and oxygen, and —(CH₂)₂₋₅—NH₂ (and N-substituted derivatives thereof). Preferred R₄ groups include —CH₂C₆H₄R₇, wherein R₇ is independently selected from hydrogen, methyl, ethyl or propyl, and in particular, —CH₂C₆H₅, as well as —(CH₂)₂₋₅—NH₂, and in particular, —(CH₂)₄NH₂.

In yet an additional sub-embodiment, R₅ is selected from hydrogen, alkyl, cycloalkyl, alkylene-cycloalkyl, and alkyl-substituted cycloalkyl. Preferred R₅ groups are C1-C6 alkyl (e.g., methyl, ethyl, propyl, butyl, pentyl, hexyl, and heptyl, and their branched counterparts, including isopropyl, isobutyl, sec-butyl, tert-butyl, etc.), and more preferably, C1-C3 alkyl. An exemplary preferred R₅ is methyl. Yet another exemplary preferred R₅ is hydrogen.

In a second embodiment, the food ingredient comprises a compound of Formula I-D,

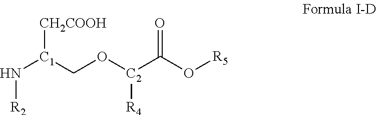

wherein (i) R₂, R₄, and R₅ are each independently selected from the substituents as described generally above. In one sub-embodiment of Formula 1-D, R₅ is selected from the group consisting of hydrogen, alkyl and cycloalkyl, the alkyl and cycloalkyl each being optionally substituted with or one or more of halogen, hydroxyl, a heteroatom, or a heteroatom-containing group, wherein the heteroatom is either N or O, and (iii) R4 is selected from —CH₂C₆H₅, and —(CH₂)₄NH₂.

In yet a further embodiment of Formula 1-D, R₄ is —CH₂C₆H₅ and R₅ is methyl.

In a third general embodiment, a food ingredient of the invention comprises a compound of Formula I-E,

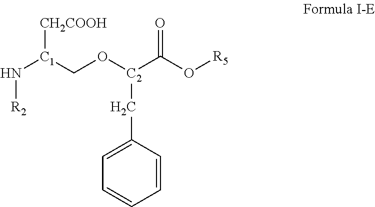

wherein R₂ and R₅ are selected from the values each as described both generally and specifically above. Formula I-E, may be considered generally as an ethoid of the aspartame skeleton, due to the aspartic acid side chain on C1 and the phenylalanine side chain on C2.

In a generally preferred sub-embodiment of Formula I-E, R₂ and R₅ is each independently selected from hydrogen and alkyl, the alkyl being optionally substituted with one or more of halogen or hydroxyl.

In yet a fourth embodiment, a food ingredient of the invention comprises a compound of Formula I-F,

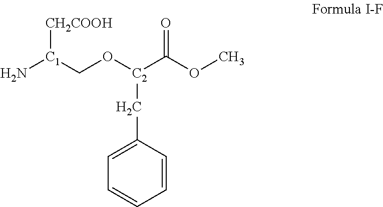

where the structure represented in Formula I-F is considered to be an ethoid analog of aspartame, where the amide bond of aspartame has been replaced by a methyleneoxy bond.

In a fifth embodiment, a food ingredient of the invention comprises a compound of Formula I-G,

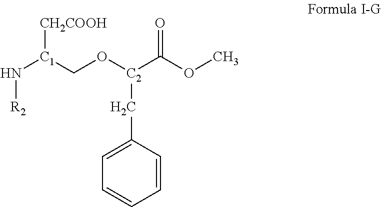

wherein R₂ is selected from any of its previously described values. In a particular and preferred sub-embodiment of the foregoing, R₂ is C1-C6 alkyl.

In yet a fifth embodiment, a food ingredient of the invention comprises a compound of Formula I-H,

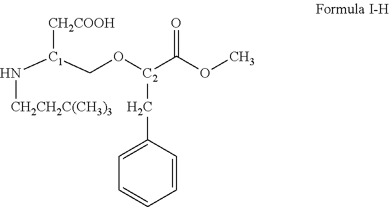

where the foregoing compound is an ethoid (in particular, a methyleneoxy ethoid) of neotame.

In yet another particular embodiment, i.e., in a sixth embodiment, a food ingredient of the invention comprises a compound of Formula I-I,

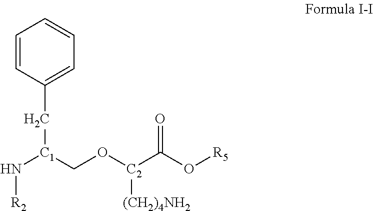

where R₂ and R₅ have values each as described both generally and specifically above. In a generally preferred sub-embodiment, R₂ is selected from the group consisting of hydrogen, alkyl, and acyl, each of the foregoing being optionally substituted with or one or more of halogen and hydroxyl, and R₅ is either hydrogen or alkyl.

In yet a further preferred embodiment, a food ingredient of the invention comprises a compound of Formula I-I, wherein R₂ is acyl and R₅ is selected from the group consisting of hydrogen and C1-C6 alkyl.

In a seventh generally preferred embodiment, the food ingredient comprises a compound of Formula I-J,

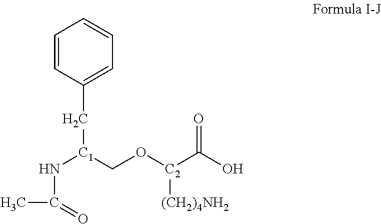

The compound corresponding to Formula I-J is referred to herein as an ethoid of inverted aspartame.

The above-described ethoid compounds (or food products as appropriate) are useful, for example, as taste-modifying agents, sweetening agents, flavor enhancers, or flavoring agents.

A food product comprising an ethoid compound as described herein may comprise any one or more of the following features: (i) is a beverage product, a cereal product, a dairy product, a frozen dessert product, a bakery product, a candy product, a gum product, or a neutraceutical product, among others; (ii) is stable to cooking; (iii) does not degrade to phenylalanine upon cooking; (iv) comprises an ethoid compound as provided herein in an amount sufficient to impart a desired level of sweetness; (v) comprises an ethoid compound as provided herein in an amount sufficient to impart a desired level of flavor enhancement; (vi) comprises a food ingredient in combination with known food ingredients.

According to a second aspect, the invention is directed to ethoid compounds as provided generally herein.

In one embodiment, the ethoid compound is in the form of a racemic mixture.

In yet another embodiment, the ethoid compound is non-racemic, where a single enantiomer or diastereomer is present in enantiomeric or diastereomeric excess, respectively, of greater than about 50%. In yet an additional embodiment, a single enantiomer or diastereomer is present in enantiomeric or diastereomeric excess of greater than about 80%, or even 90% or greater. In yet a further embodiment, provided is a non-racemic ethoid compound that is substantially enantiomerically or diastereomerically pure.

According to a third aspect, the invention encompasses a method for preparing a sweetened food product, comprising adding a sweetening effective amount of an ethoid compound as provided herein to form the sweetened food product.

In yet a fourth aspect, the invention encompasses an oral pharmaceutical composition comprising as an excipient an ethoid compound as provided herein.

In yet a fifth aspect, the invention is directed to a method for preparing a food product. The method comprises combining two or more edible ingredients, where at least one of the edible ingredients is a food ingredient comprising an ethoid compound as described herein.

In a particular embodiment of the foregoing, the two or more edible ingredients are combined to provide a food product selected from a beverage product, a cereal product, a dairy product, a frozen dessert product, a bakery product, a candy product, a gum product, and a neutraceutical product, among others.

In a further aspect, the method comprises combining three or more edible ingredients, wherein at least one of the edible ingredients is a food ingredient comprising an ethoid compound as described herein. One of ordinary skill in the art will appreciate that many more edible ingredients can be combined as well as more than one ethoid compound of the invention.

In yet a further aspect, the invention encompasses a food product comprising a food ingredient, the food ingredient being a sweetening agent comprising a peptide analog having an ethoid-containing moiety, —(CHR₃)(CR₁₀)₁₋₃OCH(R₄)—, wherein R₃ and R₄ are each an independently selected side chain moiety corresponding structurally to a side chain moiety pendant from an alpha-carbon of an amino acid. The peptide analog corresponds to a peptide chain comprising at least one ethoid bond as a replacement for the peptide amide bond.

In a generalized embodiment of the foregoing, the food ingredient comprises a compound of Formula I-A

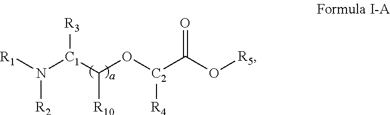

where (i) a is an integer ranging from 1 to 3, (ii) each R₁₀ is independently selected from the group consisting of H, halogen, hydroxy, C₁-C₃ alkyl and substituted C₁-C₃ alkyl, (iii) R₁, R₂ and R₅ are each independently selected from the group consisting of hydrogen, alkyl, cycloalkyl, alkylene-cycloalkyl, alkyl-substituted cycloalkyl, aryl, alkylene-aryl, alkyl-substituted aryl, and acyl, each of the foregoing being optionally substituted with or one or more of halogen, hydroxyl, heteroatom, or heteroatom-containing groups, such heteroatom being selected from N and O, and R₃ and R₄ are each independently a side chain moiety corresponding structurally to a side chain moiety pendant from an alpha-carbon of an amino acid.

In a generally preferred sub-embodiment, each of R³ and R⁴ are independently selected from a side chain moiety selected from R^{x}, R^{A}, R^{C}, R^{D}, R^{E}, R^{F}, R^{G}, R^{H}, R^{I}, R^{K}, R^{L}, R^{M}, R^{N}, R^{P}, R^{Q}, R^{S}, R^{T}, R^{U}, R^{V}, R^{W}, and R^{Y}.

In yet a further sub-embodiment, R³ and R⁴ are independently selected from a side chain moiety selected from R^{D}, R^{F}, R^{K}, R^{Q} and R^{Y}. In yet an additional embodiment, R³ and R⁴ are independently selected, in combination, such that R³ is R^{D} and R⁴ is R^{F}; or alternatively, R³ is R^{f} and R⁴ is R^{K}.

In yet an additional sub-embodiment of Formula I-A (as it pertains to a food ingredient or to an ethoid compound per se), R₃ and R₄ are each independently selected from the group consisting of —CH₂C(O)OR₆, —CH₂C₆H₄R₆, and, —(CH₂)₄NHR₆, wherein each R₆ is independently selected hydrogen, methyl, ethyl or propyl.

In an alternative sub-embodiment of Formula I-A, (i) at least one of R₁ and R₂ is other than hydrogen, or (ii) when R₁ and R₂ are both H, then R₅ is lower alkyl.

In yet a further and particular sub-embodiment, when R₁ and R₂ are both H, then R₅ is selected from lower alkyl and substituted lower alkyl.

In yet an additional aspect of the invention, provided herein is an ethoid compound in accordance with any of the foregoing aspects of the invention, including any and all sub-embodiments thereof, in packaged form.

Various features of the invention, including features defining each of the various aspects of the invention (a food product, a food ingredient, an ethoid compound, etc.), including general and preferred embodiments thereof (as well as all sub-sub-embodiments thereof), can be used in various combinations and permutations with other features of the invention. In particular, the following features are considered general features of the invention, and are expressly contemplated to be used in each possible combination and permutation with each of the aspects of the invention and with each general embodiment and preferred (sub)embodiments thereof: Each of such features are described in greater detail herein, and such detailed description is included in various combinations and hereby expressly incorporated within this paragraph.

Each of the aforedescribed general embodiments, preferred sub-embodiments and sub-sub-embodiments thereof, various features of the foregoing, and various general features are described in greater detail herein. Additional features and advantages are described herein, and will be apparent from, the following Detailed Description.

### BRIEF DESCRIPTION OF THE DRAWINGS

FIG. 1 is a graph illustrating the decomposition via cyclization over time of (i) the methyleneoxy ethoid of aspartame, and (ii) aspartame, in phosphate buffered saline solution at pH 7.5 and 65° C., as described in detail in Example 4.

FIG. 2 is a graph illustrating the rate of decomposition of aspartame at various pHs (3.4, 6.6, and 8.8) as a function of temperature. (Gaines, S. M.; Bada, J. L., J. Org. Chem., 53, 2757 and 2764 (1988)).

FIG. 3 is a graph illustrating the rate of cyclization (decomposition) of aspartame as a function of pH at 6° C. (Gaines, S. M.; Bada, J. L., J. Org. Chem., 53, 2757 and 2764 (1988)).

FIGS. 4A and 4B provide estimated stability profiles (estimated half-lives) as a function of both temperature and pH for the methyleneoxy ethoid of aspartame (FIG. 4A) and for aspartame (FIG. 4B).

FIGS. 5A and 5B illustrate the temperature stability of an exemplary ethoid of neotame compared to neotame itself. Specifically, FIG. 5A demonstrates the degradation of neotame over time at a temperature of 90° C., in a solution of phosphate buffered saline at pH 7.5. FIG. 5B provides a comparison of the rate of degradation of the methyleneoxy ethoid of neotame versus neotame over time at 60° C. in a solution of phosphate buffered saline at pH 7.5. Specifically, FIG. 5B is a plot of the natural logarithm of the concentration of (neotame/neotame ethoid) over time. The decomposition reaction proceeds via hydrolysis of the methyl ester to the corresponding di-carboxylic acid.

### DETAILED DESCRIPTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

### Definitions

It must be noted that, as used in this specification, the singular forms “a,” “an,” and “the” include plural referents unless the context clearly dictates otherwise.

In describing and claiming the present invention, the following terminology will be used in accordance with the definitions described below.

The terms sweetening agent, flavor enhancer, flavoring agent, and taste modifying agent are those understood in the food and beverage industry. For example, the FDA defines non-nutritive sweetening agents as “substances having less than 2 percent of the caloric value of sucrose per equivalent unit of sweetening capacity”. Similarly, flavor enhancers are defined as “substances added to supplement, enhance, or modify the original taste and/or aroma of a food, without imparting a characteristic taste or aroma of its own”. Flavoring agents and adjuvants are defined as “substances added to impart or help impart a taste or aroma in food.” See Title 21 C.F.R. §170.3.

For the purposes of this disclosure, an “ethoid” (as referring to a compound, such as a macromolecule, polypeptide, or oligopeptide) is an ethoid-containing compound comprising one or more ethoid moieties, preferably as isosteres.

“Lower alkyl” refers to an alkyl group containing from 1 to 6 carbon atoms, and may be straight chain or branched, as exemplified by methyl, ethyl, n-butyl, i-butyl, t-butyl.

“Aryl” means one or more aromatic rings, each of 5 or 6 core carbon atoms. Aryl includes multiple aryl rings that may be fused, as in naphthyl or unfused, as in biphenyl. Examples include phenyl, naphthyl, tetrahydronaphthyl, indanyl, indenyl, and the like. Aryl rings may also be fused or unfused with one or more cyclic hydrocarbon, heteroaryl, or heterocyclic rings. As used herein, “aryl” includes heteroaryl. The term, “alkylcycloalkyl” refers to an alkyl-substituted cycloalkane.

The term “alkylaryl” refers to an alkyl-substituted aryl group.

The term “alkylene-cycloalkyl” refers to a cycloalkyl group to which is attached an alkylene chain, where the alkylene chain may be optionally substituted with one or more substituents as described herein. An alkylene chain typically refers to one of more (—CH₂)— (methylene) groups, or substituted (—CH₂)— groups, where the number of methylene groups will typically range from 1 to about 10. The term, “alkylene” rather than alkyl is used to indicate that the alkylene function is typically attached to a moiety in addition to the cycloalkyl group.

Similarly, “alkylene-aryl” refers to an aryl group to which is attached an alkylene chain, where the alkylene chain may be optionally substituted with one or more substituents as described herein.

The term “hydrocarbyl” or “hydrocarbyl group” refers to a univalent group containing carbon and hydrogen (that is, derived from a hydrocarbon).

The phrase “enantiomeric excess” or “ee” is a measure, for a given sample, of the excess of one enantiomer over a racemic sample of a chiral compound and is expressed as a percentage. Enantiomeric excess is defined as 100×(er−1)/(er+1), where “er” is the ratio of the more abundant enantiomer to the less abundant enantiomer.

The phrase “diastereomeric excess” or “de” is a measure, for a given sample, of the excess of one diastereomer over a sample having equal amounts of diastereomers and is expressed as a percentage. Diastereomeric excess is defined as 100×(dr−1)/(dr+1), where “dr” is the ratio of a more abundant diastereomer to a less abundant diastereomer. The term does not apply if more than two diastereomers are present in the sample.

The phrases “enantiomerically pure” or “enantiopure” and “diastereomerically pure” or “diastereopure” refer, respectively, to a sample of an enantiomer or diastereomer having an ee or de of about 99% or greater.

The term “natural amino acid side chains” refers to the normal C_{α} side chains of the naturally-occurring amino acids: Ala, Cys, Asp, Glu, Phe, Gly, His, Ile, Lys, Leu, Met, Asn, Pro, Gln, Arg, Ser, Thr, Val, Trp, and Tyr and other less common but still naturally occurring amino acids. The term “non-natural amino acid side chain” refers to C_{α} side chains containing aliphatic and various aromatic side chains, not commonly found in natural amino acids, including, e.g., aromatic substitutions, aliphatic side chain substitutions, functional group modifications such as an N-acetyl, esters, or ethers.

Compounds useful in the invention include those described herein in any of their pharmaceutically acceptable forms, including isomers such as diastereomers and enantiomers, salts, solvates, and polymorphs, as well as racemic mixtures and pure isomers of the compounds described herein, where applicable.

“Pharmaceutically acceptable excipient or carrier” refers to an excipient that may optionally be included in the compositions of the invention and that causes no significant adverse toxicological effects to the patient.

“Pharmaceutically acceptable salt” includes, but is not limited to, amino acid salts, salts prepared with inorganic acids, such as chloride, sulfate, phosphate, diphosphate, bromide, and nitrate salts, or salts prepared from the corresponding inorganic acid form of any of the preceding, e.g., hydrochloride, etc., or salts prepared with an organic acid, such as malate, maleate, fumarate, tartrate, succinate, ethylsuccinate, citrate, acetate, lactate, methanesulfonate, benzoate, ascorbate, para-toluenesulfonate, palmoate, salicylate and stearate, as well as estolate, gluceptate and lactobionate salts. Similarly salts containing pharmaceutically acceptable cations include, but are not limited to, sodium, potassium, calcium, aluminum, lithium, and ammonium (including substituted ammonium).

“Optional” or “optionally” means that the subsequently described circumstance may or may not occur, so that the description includes instances where the circumstance occurs and instances where it does not.

The term “substantially” in reference to a certain feature or entity means nearly totally or completely (i.e., to a degree of 98% or greater) in reference to the feature or entity.

The term “about”, particularly in reference to a given quantity, is meant to encompass deviations of plus or minus five percent.

Additional definitions may also be found in the sections which follow.

### Overview

The various aspects, embodiments, and sub-embodiments of the invention are directed generally to ethoid compounds, and to certain characteristics and uses thereof. The inventor(s) have discovered that such ethoid compounds as provided herein (to be described in greater detail below) are particularly useful as food ingredients, and in particular, as sweetening agents. Additionally, the ethoid compounds may be employed as, taste-modifying agents, flavor enhancers, or flavoring agents. The ethoid compounds provided herein are advantageously stable to cooking and baking, thus providing a notable and significant improvement over the popular commercial artificial sweetener, aspartame. Moreover, the ethoid compounds provided herein do not produce phenylalanine upon degradation—another adverse side effect of aspartame. Additional features of ethoids and related food products, including food ingredients, as well as pharmaceutical compositions, will be described more fully hereinafter.

### Ethoid Compounds

The peptide analog compounds of the invention comprise one or more ethoid moieties. An ethoid moiety is generally a moiety that comprises an ether bond—the carbon-oxygen bond defined by a substituted or unsubstituted methyleneoxy linkage. In generally preferred aspects and embodiments of the invention, an ethoid moiety can be a substituted or unsubstituted methyleneoxy or ethyleneoxy. Generally speaking, an ethoid moiety possesses a formula

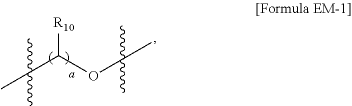

In this formula, a is an integer=1, 2 or 3. R¹⁰ is generally selected from hydrogen, halogen, hydroxyl, hydrocarbyl or substituted hydrocarbyl. More preferably R¹⁰ is selected from hydrogen, halogen, hydroxyl, C₁-C₈ alkyl and substituted C₁-C₈ alkyl. In even more preferred embodiments of the various general embodiments and aspects of the invention, R¹° is selected from H, C₁-C₃ alkyl and substituted C₁-C₃ alkyl. In preferred embodiments, at least one of the ethoid moieties is a substituted or unsubstituted methyleneoxy (e.g., a=1). In preferred embodiments, where the compound comprises more than one ethoid, each of the ethoid moieties is a substituted or unsubstituted methyleneoxy (e.g., a=1). In especially preferred embodiments, each of the ethoid moieties is an unsubstituted methyleneoxy moiety (e.g., a=1, R¹⁰═H). In some instances in this specification, an ethoid moiety is alternatively optionally referred to as an ethoid bond (e.g., conceptually in the same sense that an amide moiety within a polyaminoacid is alternatively optionally referred to as a peptide bond). Typically, preferred compounds comprise an ethoid as a replacement for an amide bond.

An ethoid compound provided herein may be an analog of a polypeptide or an oligopeptide, and is typically an analog of an oligopeptide, i.e., a compound comprising from about 2 to about 40 amino acids (e.g., 2-40 mers). As stated above, an ethoid may contain one or more ethoid bonds.

In this context, the ethoid moiety is (conceptually) a substitutive isoteric replacement for the amide bond of a peptide. An ethoid-containing analog therefore comprises at least one ethoid isostere as a replacement for the parent amide bond, and differs from an original compound with respect to the inclusion of the ethoid moiety positioned in place of the original amide moiety of the compound of interest. (Such analog may also have other additional structural variations as compared to the parent compound). Preferably, an ethoid moiety (for example, [CH₂O]) is a replacement of an amide moiety within the backbone of a polyaminoacid, or an oligopeptide (having from 2 to about 40 amino acids). Illustrative ethoid compounds having a sweetening feature (i.e., that are sweet) will typically be based upon oligopeptide having from about 2 to about 10 amino acids. Particular preferred are dipeptide-based ethoids, and in particular, those having R₁₀ equal to hydrogen. For example, —CH(R^{x})CH₂O— represents an ethoid mimetic residue of the corresponding amino acid residue, —CH(R^{x})C(O)NH—. In these exemplary formulas, for example, the ethoid moiety —CH₂0— is a replacement of the amide moiety —C(O)NH—

### Ethoid Oligopeptides

As described above, preferred ethoids are ethoids of oligopeptide compounds, i.e., peptides composed of from about two to about 40 amino acids, and comprising at least one ethoid isostere as a replacement for an amide linkage. For instance, the peptide comprising at least one ethoid isostere may contain any of the following number of residues (e.g., amino acid residues or ethoid mimetic residues): 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40. Particularly preferred are di-, tri- and 4-mer peptides, in each case comprising one or more ethoid mimetic residues.

Exemplary ethoids in accordance with various aspects of the invention are shown in Formulas I-A, I-B, I-C, I-D, I-E, I-F, I-E, I-G, I-H, I-I, I-J, II-B, III-A, III-B, III-C, III-D, III-E, IV-A, IV-B, IV-C, IV-D, IV-E, IV-F, where the values for related substituents contained therein, e.g., R₁, R₂, R₃, R₁₀, a, R₄, and R₅ are as described generally above, and in particular, in the Summary section of this document, as well as in greater detail below.

Certain illustrative ethoid dipeptides in accordance with various aspects and embodiments of the invention are shown below.

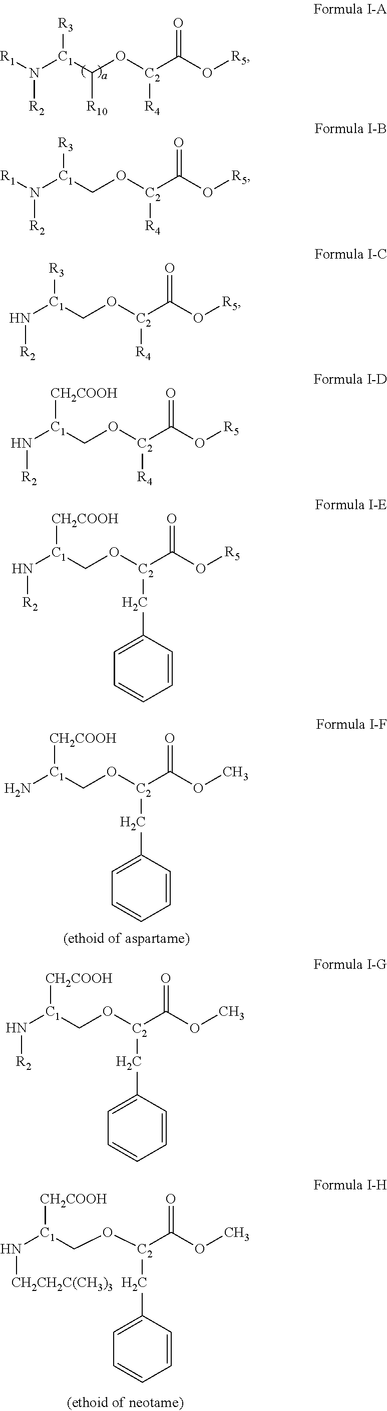

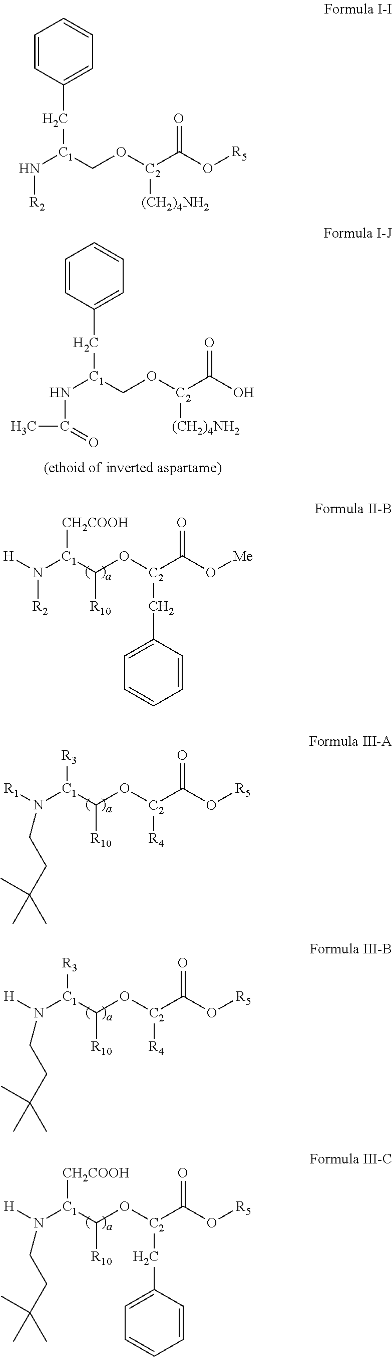

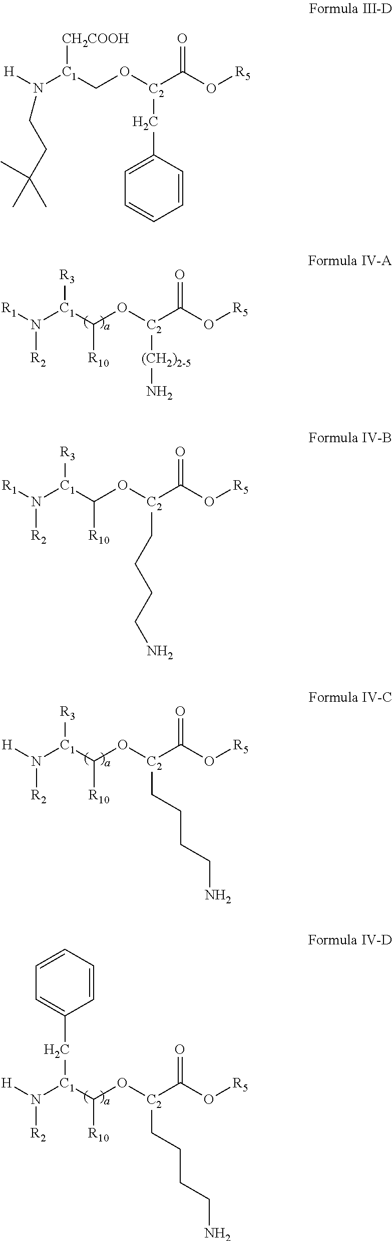

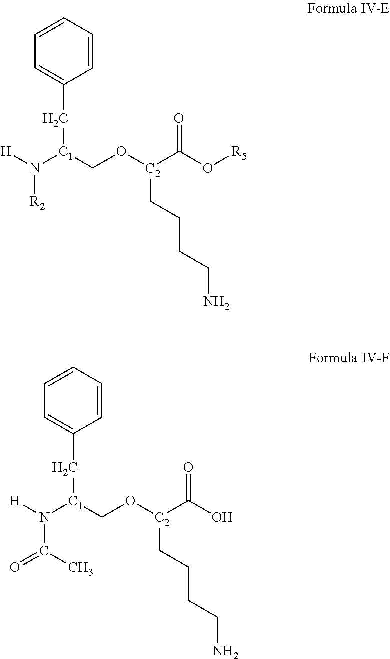

In the foregoing illustrative ethoid structures, each of the variables may possess certain preferred values from their more generalized values provided herein. For example, typically, in reference to each of the foregoing structures, a is an integer ranging from 1 to 3, e.g., is 1, 2, or 3. In certain preferred embodiments, a is 1. See, e.g., Formulae I-A, II-B, III-A, III-B, III-C, IV-A, IV-C, and IV-D. The following descriptions are meant to refer, where applicable, to each of the formulae provided above, in all possible combinations and arrangements, as permitted by the foregoing structures.

With respect to the identity of the ethoid moiety, each R₁₀ is preferably independently selected from the group consisting of hydrogen, halogen, hydroxy, C₁-C₃ alkyl and substituted C₁-C₃ alkyl. Preferred values of R₁₀ include hydrogen, methyl, and substituted methyl for each independent R₁₀. A particularly preferred R₁₀ is hydrogen. See, e.g., Formulae I-A, II-B, III-A, III-B, III-C, IV-A, IV-C, and IV-D. An even more preferred combination is “a” equal to one, and R₁₀ being hydrogen

With respect to the variables R₁ and R₂ and R₅, each may be independently selected from the following: hydrogen, alkyl, cycloalkyl, alkylene-cycloalkyl, alkyl-substituted cycloalkyl, aryl, alkylene-aryl, alkyl-substituted aryl, and acyl, each of the foregoing being optionally substituted with or one or more of halogen (e.g., fluorine, chlorine, iodine), hydroxyl, heteroatom, or heteroatom-containing groups, such as nitrogen or oxygen. In one or more preferred general embodiments, R₁, R₂ and R₅, may each be independently selected from the following: hydrogen, alkyl, cycloalkyl, aryl, alkyl-substituted cycloalkyl, alkyl-substituted aryl, and acyl.

In certain instances, R₂ is selected from hydrogen and alkyl, the alkyl being optionally substituted with one or more of halogen or hydroxyl, and R₁ is hydrogen. Exemplary R₂ substituents include CH₃(CH₂)₂CH₂—, (CH₃)₂CHCH₂—, (CH₃)₂CHCH₂CH₂—, CH₃CH₂CH(CH₃)CH₂—, (CH₃CH₂)₂CHCH₂—, (CH₃)₃CCH₂CH₂—, cyclohexyl, cycloheptyl, cyclooctyl, cyclopentylmethyl, cyclohexylmethyl, 3-phenylpropyl, 3-methyl-3-phenylpropyl, 3,3-dimethylcyclopentyl, 3-methylcyclohexyl, 3,3,5,5-tetramethylcyclohexyl, 2-hydroxycyclohexyl, 3-(4-hydroxy-3-methoxyphenyl)propyl. Alternatively, R₂ is any of a number of acyl groups (also known as an alkanoyl group) derived from a corresponding carboxylic acid, such as methanoic, ethanoic, propanoic acid, and the like. In a particularly preferred embodiment, the acyl group corresponds to the formula —C(O)—R, where R is methyl.

Exemplary R₅ groups include alkyl, cycloalkyl, alkylene-cycloalkyl, alkyl-substituted cycloalkyl, hydroxyl, and alkoxy (—OR). Preferred R₅ groups are C1-C6 alkyl (e.g., methyl, ethyl, propyl, butyl, pentyl, hexyl, and heptyl, and their branched counterparts, including isopropyl, isobutyl, sec-butyl, tert-butyl, etc.), and more preferably, C1-C3 alkyl. An exemplary R₅ is methyl. Yet another exemplary R₅ is hydrogen.

A preferred R₁ is hydrogen. (Note that chemically speaking, the substituents R₁ and R₂ on the amino terminus are identical, however, for ease of reference, they are provided individual identifiers herein.)

Exemplary R₃ and R₄ groups include the following: alkyl, cycloalkyl, alkylene cycloalkyl, alkyl-substituted cycloalkyl, aryl, alkylene-aryl, alkyl-substituted aryl, and acyl, each of the foregoing being optionally substituted with or one or more heteroatom, or heteroatom-containing groups, such as nitrogen, oxygen and sulfur. In one or more particular embodiments, R₃ is selected from —(CH₂)ₙC(O)OR₆, and —X—(CH₂)ₙ—C₆H₄R₇, where R₆ is independently selected from hydrogen, methyl, ethyl, propyl and butyl, R₇ is independently selected from hydrogen, methyl, ethyl, propyl, butyl, and hydroxyl, where R₇ may be in an ortho, meta or para position on the phenyl ring, each n is independently an integer from 1-4 (e.g., is selected from 1, 2, 3, and 4), and X is O, —NH, or S. A preferred R₃ group, in one or more embodiments, is —CH₂COOR₆, or even more preferably, —CH₂COOH.

Illustrative R₄ groups may additionally include N-substituted amides. Particular R₄ groups include —(CH₂)ₙC₆H₄R₇ and —(CH₂)ₙ-C5-C7 cycloalkyl, where the cycloalkyl is optionally substituted with one or more heteroatom-containing groups, and —C(O)NHR₈, where R₇ is selected from hydrogen, methyl, ethyl, propyl, butyl, and hydroxyl, and may be in an ortho, meta or para position, n is independently an integer from 1-4, and R₈ is selected from alkyl, cycloalkyl, alkylene-cycloalkyl, alkylene-aryl, each of the foregoing being optionally substituted with or one or more heteroatoms, or heteroatom-containing groups, such as nitrogen, sulfur, and oxygen, and —(CH₂)₂₋₅—NH₂ (and N-substituted derivatives thereof). Preferred R₄ groups include —CH₂C₆H₄R₇, wherein R₇ is independently selected from hydrogen, methyl, ethyl or propyl, and in particular, —CH₂C₆H₅, as well as —(CH₂)₂₋₅—NH₂, and in particular, —(CH₂)₄NH₂.

Particularly preferred compounds are the ethoid of aspartame (I-F), the ethoid of neotame (formula I-H), and the ethoid of inverted aspartame (Formula I-J). The ethoid of aspartame is also referred to herein as Compound 1 (see Example 1); the ethoid of inverted aspartame is also referred to herein as Compound 2 (see Example 2); the ethoid of aspartame is also referred to herein as Compound 3 (see Example 6).

Additional structures include, but are not limited to, ethoid compounds of the analogous amide peptides found in Nosho, et. al., Molecular Design of Inverted-Aspartame-Type Sweeteners,” J. Agric. Food Chem., 1990, 38, 1368-73, and Goodman et. al. (“Molecular basis of Sweet Taste in Dipeptide Taste Ligands” Pure Appl. Chem., 2002, 74, 1109-16.)

For example, additional structures include those generally represented by the formula —C₁H(R₃)(CH(R₁₀))ₐO—C₂HR₄ (Formula EMR-2), where R¹⁰ and “a” are defined as described above in connection with Formula EM-1. As used in the context of ethoid-containing mimetics of amino acid residues, —R³ and R₄ generally represent a side-chain moiety corresponding structurally to a side-chain moiety selected from side chain moieties pendant from alpha carbons of amino acid residues. For common amino acid residues having accepted single-letter identifiers, the superscripted “3” or “4” corresponds to the single-letter identifier of the amino acid residue. For example, —R^{A} represents the side-chain moiety corresponding to the side-chain moiety pendant from the alpha carbon of an Alanine residue: —CH₃. Abbreviations for commonly known, genetically-encoded amino acid residues, and their respective alpha-carbon side chain moieties (each suitable for example as R³ or R₄ as used herein, including for example and without limitation in connection with Formula EMR-1 and/or Formula EMR-2) are set forth in Table 1.A, below. In addition to such common side chain moieties (e.g., having single-letter or three-digit identifiers), the other side chain moieties are likewise suitable as R³ or R³ as used herein. For example, each R^{X} can generally be an independently selected side chain moiety comprising hydrocarbyl or substituted hydrocarbyl. Preferably such side chain moieties, R^{X}, can each be independently selected from the group consisting of H, C₁-C₁₀ alkyl and substituted C₁-C₁₀ alkyl, and which in each case can optionally form one or more ring structures, for example with respective opposing side chain moieties or with adjacent side chain moieties or with an atom on the backbone of the polyethoid moiety. Each of the various side chain moieties, R^{X}, as described herein and elsewhere are contemplated and included in each case in both functional-group protected or unprotected forms.

A list of abbreviations for common genetically-encoded amino acids, and their alpha-carbon side chains (suitable for example as R^{X}) as used in this application are set forth in Table I.A.

TABLE 1.A
—R^{X} (Common Amino Acid Side Chains)

| R^{X} | Side chain | Parent amino acid |
|---|---|---|
| ′R^{A} | —CH₃ | Alanine |
| R^{C} | —CH₂SH | Cysteine |
| R^{D} | —CH₂COOH | Aspartate |
| R^{E} | —CH₂CH₂COOH | Glutamate |
| R^{F} | —CH₂C₆H₅ | Phenylalanine |
| R^{G} | —H | Glycine |
| R^{H} | —CH₂—C₃H₃N₂ | Histidine |
| R^{I} | —CH(CH₃)CH₂CH₃ | Isoleucine |
| R^{K} | —(CH₂)₄NH₂ | Lysine |
| R^{L} | —CH₂CH(CH₃)₂ | Leucine |
| R^{M} | —CH₂CH₂SCH₃ | Methionine |
| R^{N} | —CH₂CONH₂ | Asparagine |
| R^{P} | —CH₂CH₂CH₂— | Proline |
| R^{Q} | —CH₂CH₂CONH₂ | Glutamine |
| R^{R} | CH₂)₃NH—C(NH)NH₂ | Arginine |
| R^{S} | —CH₂OH | Serine |
| R^{T} | —CH(OH)CH₃ | Threonine |
| R^{U} | —CH₂SeH | Selenocysteine |
| R^{V} | —CH(CH₃)₂ | Valine |
| R^{W} | —CH₂C₈H₆N | Tryptophan |
| R^{Y} | —CH₂—C₆H₄OH | Tyrosine |

Other side chain moieties pendant from alpha carbons of other amino acid residues are disclosed in Table 1.B. (Table I.B includes some three letter abbreviations for the residues/an amino acid side chains).

TABLE 1.B
—R^{X} (Other Amino Acid Side Chains)

—CH₂CH═CH₂,
-(2-indanyl),
-(2-thiazoyl),
-(2-thienyl),
-(3-thienyl),
—(CH₂)₂CONHCH₂CH₃,
—(CH₂)₂NH₂,
—(CH₂)₂OBzl,
—(CH₂)₂Ph,
—(CH₂)₂S(═O)(═NH)((CH₂)₃CH₃),
—(CH₂)₂S(CH₂)₃CH₃,
—(CH₂)₂S(CH₃)₂⁺Cl⁻,
—(CH₂)₂SCH₂CH₃,
—(CH₂)₂SCH₂Ph,
—(CH₂)₂SeCH₃,
—(CH₂)₃CH₃ (Nle)
—(CH₂)₃COOH,
—(CH₂)₃NH₂, (Orn)
—(CH₂)₃NHC(═NH)NHNO₂,
—(CH₂)₃NHCONH₂, (Cit)
—(CH₂)₄CH₃,
—(CH₂)₄COOH,
—(CH₂)₄N₃,
—(CH₂)₄NHC(═NEt)NHEt,
—(CH₂)₄NMe₂,
—(CH₂)₄NMe₃⁺Cl⁻,
—(CH₂)₅CH₃,
—(CH₂)₅COOH,
-4-(1-benzyl)imidazolyl,
—C(CH₃)₂S(CH₂)₂-(₄-pyridyl),
—C(CH₃)₂SCH₂-(4-methoxyphenyl),
—C(CH₃)₂SCH₂-(4-methylphenyl),
—C(CH₃)₂SCH₂NHCOCH₃,
—C(CH₃)₂SH,
—C(CH₃)₃,
—C(OCH₃)CH₃,
—C(OH)(CH₃)₂,
—C(OH)CH₂CH₃,
—CFMe₂,
—CH(CH₃)(COOH),
—CH(CH₃)CH₂COOH,
—CH(CH₃)OCH₂CH₃,
—CH(CH₃)OCH₃,
—CH(CH₃)Ph,
—CH(Me)(CF₃),
—CH(OH)CH(CH₃)₂,
—CH(OH)CH(CH₃)CH₂CH═CHCH₃,
—CH(OH)CH(OH)Ph,
—CH(OH)CH₂CH₂NH₂,
—CH(OH)Ph,
—CH(Ph)₂, (Dif)
—CH═CCl₂,
—CH₂-(1-naphthyl),
—CH₂-(1-pyrenyl),
—CH₂-(2,4-dichlorophenyl),
—CH₂-(2,4-dihydroxyphenyl),
—CH₂-(2-bromophenyl),
—CH₂-(2-chlorophenyl),
—CH₂-(2-cyanophenyl),
—CH₂-(2-fluorophenyl),
—CH₂-(2-guanidinophenyl),
—CH₂-(2-hydroxyphenyl),
—CH₂-(2-methylphenyl),
—CH₂-(2-naphthyl),
—CH₂-(2-nitrophenyl),
—CH₂-(2-pyridyl),
—CH₂-(2-pyridyl),
—CH₂-(2-thienyl), (Thi)
—CH₂-(2-trifluoromethyl-phenyl),
—CH₂-(3-(1-methylindolyl)),
—CH₂-(3-(1-phenylthiocarbamate-
indolyl)),
—CH₂-(3-(4-methylindolyl)),
—CH₂-(₃-(₅-benzyloxyindolyl)),
—CH₂-(₃-(₅-bromoindolyl)),
—CH₂-(3-(5-chloroindolyl)),
—CH₂-(3-(5-fluoroindolyl)),
—CH₂-(3-(5-hydroxyindolyl)),
—CH₂-(3-(5-methoxy-2-methyl-indolyl)),
—CH₂-(3-(6-bromoindolyl)),
—CH₂-(3-(6-chloroindolyl)),
—CH₂-(3-(6-fluoroindolyl)),
—CH₂-(3-(6-methylindolyl)),
—CH₂-(3-(7-benzyloxyindolyl)),
—CH₂-(3-(7-bromoindolyl)),
—CH₂-(3-(7-methylindolyl)),
—CH₂-(3,4,5-trifluorophenyl),
—CH₂-(3,4-dichlorophenyl),
—CH₂-(3,4-difluorophenyl),
—CH₂-(3,4-dimethoxyphenyl),
—CH₂-(3,5-diiodo-4-hydroxy-phenyl),
—CH₂-(3-amino-4-hydroxy-phenyl),
—CH₂-(3-benzothienyl),
—CH₂-(3-bromophenyl),
—CH₂-(3-chlorophenyl),
—CH₂-(3-cyanophenyl),
—CH₂-(3-fluorophenyl),
—CH₂-(3-guanidinophenyl),
—CH₂-(3-hydroxyphenyl),
—CH₂-(3-iodophenyl),
—CH₂-(3-methoxy-4-hydroxy-phenyl),
—CH₂-(3-methylphenyl),
—CH₂-(3-nitro-4-hydroxy-phenyl),
—CH₂-(3-nitrophenyl),
—CH₂-(3-pyridyl),
—CH₂-(3-styryl),
—CH₂-(3-trifluoromethyl-phenyl),
—CH₂-(4-(4-hydroxyphenoxy)-phenyl),
—CH₂-(4-(bis-2-
chloroethyl)aminophenyl),
—CH₂-(4-aminomethyl-phenyl),
—CH₂-(4-aminophenyl),
—CH₂-(4-benzoylphenyl) (Bpa,
—CH₂-(4-bromophenyl),
—CH₂-(4-chlorophenyl),
—CH₂-(4-cyanophenyl),
—CH₂-(4-ethoxyphenyl),
—CH₂-(4-fluorophenyl),
—CH₂-(4-guanidinophenyl),
—CH₂-(4-iodophenyl),
—CH₂-(4-methoxyphenyl),
—CH₂-(4-methylphenyl),
—CH₂-(4-nitrophenyl),
—CH₂-(4-pyridyl),
—CH₂-(4-sulfoxy-phenyl),
—CH₂-(4-trifluoromethyl-phenyl),
—CH₂-(5-bromo-2-methoxyphenyl),
—CH₂-(cyclopenten-1-yl),
—CH₂-(pentafluorophenyl),
—CH₂C(═CH₂)(COOH),
—CH₂CCH,
—CH₂CF₃,
—CH₂CH(CH₃)(CF₃),
—CH₂CH(COOH)₂,
—CH₂CH₂CH₃,
—CH₂CH₂-cyclohexyl,
—CH₂CN,
—CH₂CO-(2-amino-phenyl),
—CH₂-cyclohexyl (Cha)
—CH₂-cyclopentyl,
—CH₂-cyclopropyl,
—CH₂NH₂,
—CH₂NHC(═NH)NH₂,
—CH₂NHCONH₂,
—CH₂O-octanoyl,
—CH₂S(CH₂)₂-(4-pyridyl),
—CH₂S(CH₂)₂COOH,
—CH₂S(CH₂)₂OH,
—CH₂S(CH₂)₃NH₂,
—CH₂SC(CH₃)₃,
—CH₂SCH(Ph)₂,
—CH₂SCH₂CH₃,
—CH₂SCH₂COOH,
—CH₂SCH₂Ph,
—CH₂SCH₃,
—CH₂SCONH₂,
—CH₂S-farnesyl,
—CH₂^{t}Bu.
—Ph
-cyclohexyl
—CH₂SO₃H
—CH₂CH₃
—CH₂Cl
—CH₂OCH₃
—CH₂OBzl
—CH₂O^{t}Bu
—CH₂OCH₂CH₃
—CH₂N(CH₃)₂
-(2,4-dinitro)phenyl
-(2,5-dihydro)phenyl
-(2-bromo)phenyl
-(2-fluoro)phenyl
-(2-methoxy)phenyl
-(2-methyl)phenyl
-(4-fluoro)phenyl
-(4-hydroxy)phenyl
-cyclopentyl

The ethoid analogs described herein may possess one or more chiral centers. Illustrative ethoid dipeptides as provided herein will often contain one, two, three, four or five chiral carbons, depending upon the values of the variables a, R₁₀, R₃ and R₄. Typically, an ethoid dipeptide will contain one or two chiral carbons. For example, in examining the exemplary formulae above, it can be seen that in instances in which R₃ and R₄ are non-identical, both C₁ and C₂ are chiral centers. Ethoid compounds as provided herein may be racemic mixtures, or may be enantiomerically enriched, diastereomerically enriched or even enantiomerically or diasastereomerically pure. For ethoids that are non-racemic mixtures, generally one enantiomer or diastereomer will be present in an excess of at least 20%. Illustrative enantiomeric or diastereomeric excesses include 20% or greater, 25% or greater, 30% or greater, 40% or greater, 50% or greater, 60% or greater, 70% or greater, 75% or greater, 80% or greater, 90% or greater, or even 95% or greater. In some instances, a compound may be enantiomerically or diastereomerically pure, meaning an excess of at least 99%.

Method of Making

Preparation of illustrative ethoid compounds is described in detail in Examples 1, Example 2, and Example 6. Turning to Example 1 as an illustration, an ethoid compound may be prepared advantageously according to the following synthetic methodology, where precursors to each of the amino acid residues, optionally in modified form, are prepared and then coupled via an ethoid isostere to provide an ethoid compound. Generally speaking, a preferred approach is to modify each of the alpha amino and carboxyl portions in the individual amino acid building blocks (further modified if desired), by converting the alpha amino group in a particular amino acid building block to a silyl ether, converting the carboxy group in another amino acid building block to an aldehyde (while introducing necessary protecting groups), and then coupling the silyl ether and the aldehyde under reducing conditions (reductive etherification) to form the desired ethoid compound. See for example, the illustrative reaction schemes in Examples 1, 2, 5 and 6.

As can be seen, to prepare a compound such as the methyleneoxy ethoid of aspartame, the alpha amino group (corresponding to the amide nitrogen in the corresponding peptide compound) of the methyl ester of phenylalanine is first converted under suitable conditions to a hydroxyl group, which is then silylated using a silylating agent (e.g., dimethylt-butylsilyl halide) to form the corresponding silyl ether. Another building block, in the current example, aspartic acid, having the alpha amino group (and in this case, also the beta carboxy group) in protected form, is converted to the corresponding Weinreb amide (˜C(O)—NR—O˜), which is then reduced in the presence of a suitable reducing agent, (e.g., LiAlH4 or the like) to the corresponding aldehye. The aldehye and the silyl ether are then coupled under suitable conditions (e.g., in the presence of a bismuth trihalide and a silane such as triethylsilane) to form the corresponding protected ethoid (where the aldehyde carbon is reduced to a methylene group). The protected ethoid is then deprotected using appropriate deprotecting conditions, to form the desired ethoid compound.

Turning now to the preparation of the ethoid of inverted aspartame, as described in detail in Example 2, it can be seen that a similar approach is employed. Generally, the alpha amino group of lysine, having the terminal amino group in protected form, is converted to the corresponding alpha hydroxyl group, which is then converted to the corresponding silyl ether. The carboxy group of N-acetylated phenylalanine is converted to the corresponding Weinreb amide, followed by reduction to form the aldehyde. The aldehye and silyl ether building blocks are then coupled to form the corresponding protected ethoid, which is then deprotected to provide the ethoid of inverted aspartame (Compound 2). Suitable protecting groups and reaction conditions can be found in Greene, T. W., et al., PROTECTIVE GROUPS IN ORGANIC SYNTHESIS, 3rd ed., John Wiley & Sons, Inc., New York, N.Y. (1999), and also in Kocienski, P., PROTECTING GROUPS, 3rd ed., Georg Thieme Verlag (2003).

The preparation of the methyleneoxy ethoid of neotame is described in Example 6.

Using the generalized synthetic approaches described herein, any of a number of ethoid compounds can be similarly prepared

The invention further encompasses an ethoid compound, and in particular, one having a sweetening potency, prepared as described both generally and specifically herein.

Food Products/Food Ingredients

It has been discovered that the ethoid compounds provided herein, and in particular, ethoid dipeptides, are especially useful as food ingredients, and in particular, as sweetening agents, flavor enhancers, taste-modifiers, and the like, due to a number of features which make the ethoids more attractive than known artificial sweeteners, such as aspartame. The terms sweetening agent, flavor enhancer, flavoring agent, and taste modifying agent are those understood in the food and beverage industry. For instance, the FDA defines non-nutritive sweetening agents as “substances having less than 2 percent of the caloric value of sucrose per equivalent unit pf sweetening capacity”. The FDA defines flavor enhancers as “substances added to supplement, enhance, or modify the original taste and/or aroma of a food, without imparting a characteristic taste or aroma of its own”. The FDA defines flavoring agents and adjuvants as “substances added to impart or help impart a taste or aroma in food”. See 21 C.F.R. §170.3.

See, for example, Example 3, which describes the sweetening potency of exemplary compounds 1 and 2. Sweetening potency is the relative sweetening effect of an artificial sweetener relative to sugar at an equivalent concentration. Compounds 1 and 2, illustrative of the ethoids of the invention, were found to be significantly sweeter than sugar; moreover, compound 1 was reported to be several-fold sweeter than aspartame. (Recall that aspartame is reported to be approximately 150 times sweeter than sugar).

Ideally, an ethoid-based food ingredient of the invention will possess a sweetness potency at least twice that of sugar. Preferably, an ethoid-based sweetener will possess a sweetness potency that is at least 5 times that of sugar (e.g., 2 times, 3 times, 4 times, or 5 times or greater), or more preferably, at least 10 times that of sugar. Even more preferably, an ethoid based sweetener will possess a sweetness potency that is at least 5 times that of aspartame (e.g., 2 times, 3 times, 4 times, or 5 times or greater), or more preferably, at least 10 times that of aspartame.

The discovery that ethoid compounds such as those exemplified herein possess sweetness was surprising, particularly in view of the results of studies of the metabolic cleavage of the amide bond between the two amino acids in aspartame. Such results indicate a loss of sweetness and the formation of phenylalanine. Similarly, deesterification of the methyl ester in aspartame also produces loss of sweetness. Studies into the structure activity relationship of aspartame to sweetness characteristics have demonstrated that the amide bond is critical to its sweetness. Modifying the amide bond by conversion to an ester, N-methylation, or reversal of its direction results in complete loss of sweetness. (“Peptide Sweeteners. 3. Effect of Modifying the Peptide Bond on the Sweet Taste of L-aspartyl-L-phenylalanine Methyl Ester and Its Analogues” J. Med. Chem. 1980, 23, 413-20). In view of the foregoing, it was completely unexpected that the current ethoids, and in particular, compounds 1, 2, and 3, should have any degree of sweetness, since the amide bond connecting the two amino acid residues, stated to be critical to sweetness, is replaced by an ethoid.

Food products as provided herein are those used within the food and beverage industry to prepare food products for human or animal consumption. Food products include, e.g., cereals, beverages (e.g., soft drinks, flavored drinks such as lemonade, tea, coffee, and the like) dairy products, frozen desserts, bakery products, table top sweeteners, toppings, fillings, fruit spreads, gums, candy, vitamins, nutraceuticals, and pharmaceutical compositions, in particular, oral compositions. A food product in accordance with the invention is one comprising a food ingredient, where the food ingredient comprises an ethoid as provided in accordance with any one of the aspects, embodiments or sub-embodiments of the invention provided herein. Optionally, the food product comprises two or more edible ingredients, at least one being a food ingredient comprising an ethoid compound as provided herein.

A food product comprising an ethoid compound may be prepared by any of a number of methods. Also provided herein is a method of substituting an ethoid compound as provided herein for sucrose in a food product, to impart a sweet taste thereto. For example, a given food product is prepared such that an appropriate amount of one or more ethoid compounds is substituted for sucrose (or another sweetening agent) to thereby impart a sweet taste to the food product. Illustrative food products include soft drinks, dairy based drinks (e.g., chocolate milk, cocoa, eggnog, drinkable yogurt, whey based drinks), fermented and renneted milk products, beverage whiteners, whipping or whipped and reduced fat creams, clotted cream, milk and cream powder analogs, cheese analogues, dairy based foods (e.g., milk, pudding, fruit, flavored yogurt), fat-based desserts, edible ices, frozen fruit, dried fruit, canned fruit, jams, jellies, marmalades, fruit-based spreads, candied fruit, fruit-based desserts, frozen vegetables. The ethoid may be added as a solid, or dissolved, and then added, to provide a food product having a desired characteristic (e.g., sweetness, enhanced flavor, modified taste, etc.). An ethoid compound need not be present at levels sufficient to impart sweetness, but may be present at sub-sweetening levels, but in an amount sufficient to enhance the flavor of a food product.

An ethoid compound may be added to a food product by mixing, blending, stirring, shaking, or by using any technique commonly employed to add an ingredient to a food product. Due to the remarkable stability of the present ethoids, an ethoid compound can typically be added to a food product over a wide range of conditions. For example, an ethoid may be added during food product preparation at low temperatures, room temperature, at elevated temperatures (such as those used in baking), and even be submitted to pasteurization, including both high temperature short-time (HTST) processes and ultra-high temperature processes (UHT).

The exemplary ethoid compounds are advantageously used in beverage applications where the beverages have neutral rather than acidic pHs. As can be seen from the data provided herein, in contrast to aspartame, the ethoid compounds are stable under neutral pH conditions. Due to their enhanced stability, the ethoids can be advantageously used in food products that, during shipment, storage, shelf-life, and/or use, are exposed to high temperature conditions.

The ethoid compounds described herein may be supplied as bulk material, but may also be in packaged form, e.g., in individual packets, or in a carton, box, in liquid form, canister, or any other container used to package solid or liquid food products.

Ideally, the ethoid peptide analog is in a form similar to sugar—is a white powder. Additionally, the ethoid peptide may be part of a blended composition comprising one or more available artificial or natural sweeteners, flavorants, binders, fillers, carriers, and the like, to attain a desired taste profile. Examples of suitable additives include dextrose, polydextrose, starch, maltodextrin, cellulose, methylcellulose, sodium alginate, pectins, gum Arabic, lactoxe, maltose, glucose, sucrose, leucine, glycerole, mannitol, sorbitol, xylitol, erythritol, and the like. Also, such compositions may further comprise a drying agent such as silicon dioxide, tricalcium phosphate, and the like.

Pharmaceutical Excipient

The ethoids of the invention may also form part of a pharmaceutical formulation, such as an oral dosage form. The ethoid may be present as an excipient, or contained in a film or coating. Illustrative oral dosage forms include tablets, caplets, capsules, lozenges, syrups, suspensions, emulsions, and the like.

An ethoid compound may be contained in a pharmaceutical formulation for veterinary and/or for human medical use. In addition to one or more therapeutic agents, such a formulation may also contain one or more pharmaceutically acceptable carriers in addition to the ethoid. Such compositions may further include diluents, buffers, binders, disintegrants, thickeners, lubricants, preservatives (including antioxidants), flavoring agents, taste-masking agents, inorganic salts (e.g., sodium chloride), antimicrobial agents (e.g., benzalkonium chloride), sweeteners, antistatic agents, surfactants (e.g., polysorbates such as “TWEEN 20” and “TWEEN 80”, and pluronics such as F68 and F88, available from BASF), sorbitan esters, lipids (e.g., phospholipids such as lecithin and other phosphatidylcholines, phosphatidylethanolamines, fatty acids and fatty esters, steroids (e.g., cholesterol)), and chelating agents (e.g., EDTA, zinc and other such suitable cations). Other pharmaceutical excipients and/or additives suitable for use in such compositions can be found in “Remington: The Science & Practice of Pharmacy”, 19th ed., Williams & Williams, (1995), and in the “Physician's Desk Reference”, 52nd ed., Medical Economics, Montvale, N.J. (1998), and in “Handbook of Pharmaceutical Excipients”, Third Ed., Ed. A. H. Kibbe, Pharmaceutical Press, 2000.

When used as an excipient, the amount of ethoid in the formulation will vary widely depending upon the particular therapeutic agent and its activity, as well as the particular type of formulation. Pharmaceutical compositions will generally contain anywhere from about 0.1% by weight to about 50% by weight ethoid, typically from about 1% to about 40% by weight ethoid, and more typically from about 1% to 35% by weight ethoid, and will also depend upon the relative amounts of other excipients/additives contained in the composition. Illustrative amounts of ethoid (by weight percent) include no more than about 1% , 2%, 5%, 10%, 15%, 20%, 30%, 40%, and even 50% by weight.

Related Features

The exemplary ethoids of the invention provide several advantages over certain known artificial sweeteners. For instance, as demonstrated in Example 4, the corresponding ethoid of aspartame is significantly more stable in solution than is aspartame under identical conditions. Indeed, the stability of the ethoid of aspartame was significantly enhanced (over a hundred-fold) over that of aspartame, even at elevated temperatures. Thus, the ethoids and related food products provided herein provide an advantage over similar aspartame-based compositions and products, due to their stability at elevated temperatures, lending to their use in baked goods and those requiring heating. Thus, under certain conditions, a food product comprising an ethoid peptide will typically maintain an initial sweetness over an extended period of time when compared to the same sweetened composition in which the ethoid peptide is replaced with an equivalent sweetening amount of aspartame.

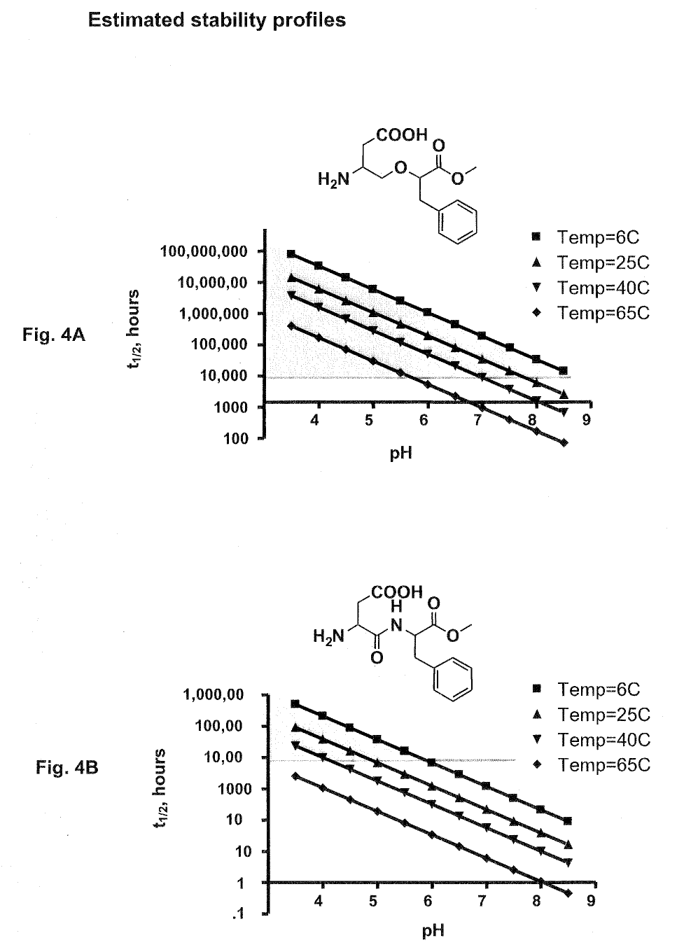

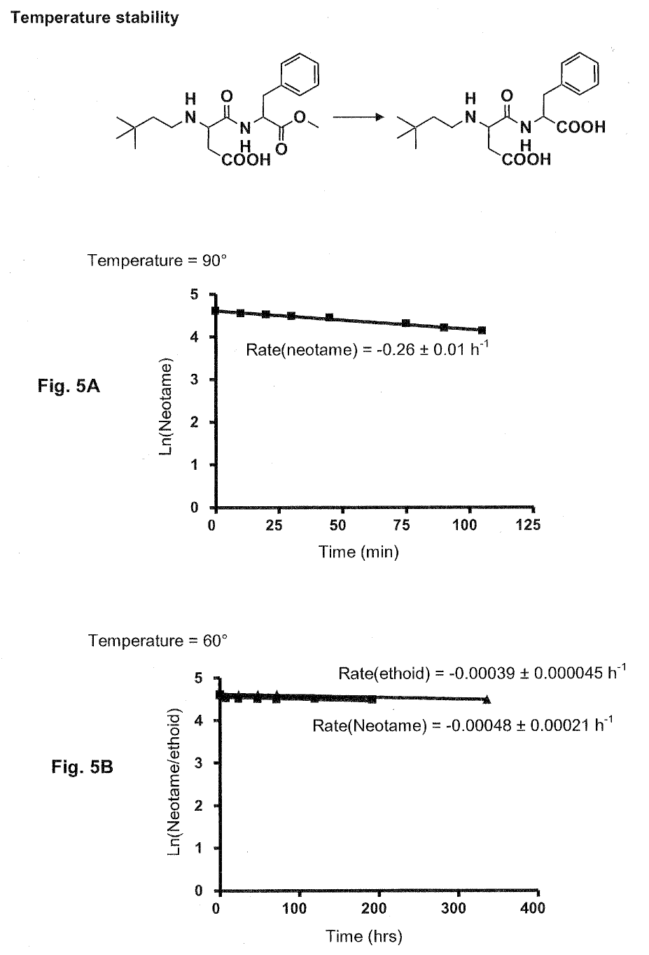

Advantageously, unlike aspartame, the current ethoids are stable under neutral pH conditions—thereby extending their use to products in which aspartame is unstable. See, e.g., FIGS. 4A and 4B and 5A and 5B.

Lastly, as can be seen in Example 4, compound 1 (and indeed, compounds 2 and 3) possesses the added advantage of no diketopiperazine (dkkp) formation upon degradation, again offering an additional significant advantage over aspartame due to the formation of non-deleterious degradants. Further, the ethoid of aspartame, as well as other representative ethoids, does not form phenylalanine upon degradation—making such compounds suitable for use by individuals suffering from phenylketonuria, a disorder characterized by a deficiency in the enzyme phenylalanine hydroxylase, which s necessary to metabolize the amino acid phenylalanine to the amino acid tyrosine.

Thus, the ethoids of the invention, when packaged in a suitable container, do not require special labelling or warnings for consumers possessing phenylketonuria.

The ethoids provided herein are therefore useful as food ingredients, and can be incorporated into a food product through any method typically used for food ingredients. The ethoid is typically incorporated into a food product in an amount sufficient to impart the desired level of a food characteristic, such as sweetness or even flavor enhancement. Typically, the quantities employed for taste enhancement are less than those to achieve sweetness. Alternatively, the ethoids of the invention may be provided in neat form—not as part of a food composition but provided as compound per se.

Use levels of exemplary ethoids as food ingredients may range from about 1 ppm to about 1500 ppm, depending upon the particular application.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### EXAMPLES

The practice of the invention will employ, unless otherwise indicated, conventional techniques of organic synthesis and the like, which are within the skill of the art. Such techniques are fully described in the literature. Reagents and materials are commercially available unless specifically stated to the contrary. See, for example, M. B. Smith and J. March, March's Advanced Organic Chemistry: Reactions Mechanisms and Structure, 6th Ed. (New York: Wiley-Interscience, 2007), supra, and Comprehensive Organic Functional Group Transformations II, Volumes 1-7, Second Ed.: A Comprehensive Review of the Synthetic Literature 1995-2003 (Organic Chemistry Series), Eds. Katritsky, A. R., et al., Elsevier Science.

In the following examples, efforts have been made to ensure accuracy with respect to numbers used (e.g., amounts, temperatures, etc.) but some experimental error and deviation should be accounted for. Unless indicated otherwise, temperature is in degrees C. and pressure is at or near atmospheric pressure at sea level.

The following examples illustrate certain aspects and advantages of the present invention, however, the present invention is in no way considered to be limited to the particular embodiments described below.

### ABBREVIATIONS AND ACRONYMS

DCM dichloromethane

DIC 1,3-diisopropylcarbodiimide

DMAP N,N-dimethylaminopyridine

DMF N,N-dimethylformamide

HOBT N-hydroxybenzotriazole

NBS N-bromosuccinimide

NMM N-methylmorpholine

PBS phosphate buffered saline

THF tetrahydrofuran

TLC thin layer chromatography

TFA trifluoroacetic acid

### Materials and Methods

An Applied Biosystem MS API 150 EX mass spectrometer was employed, with an area scan between 100-800 amu.

### Example 1

### Synthesis of Methyleneoxy Ethoid of Aspartame

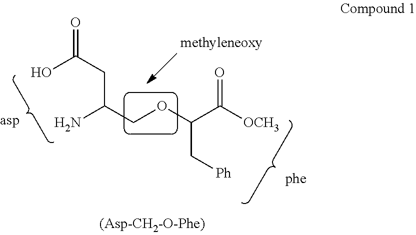

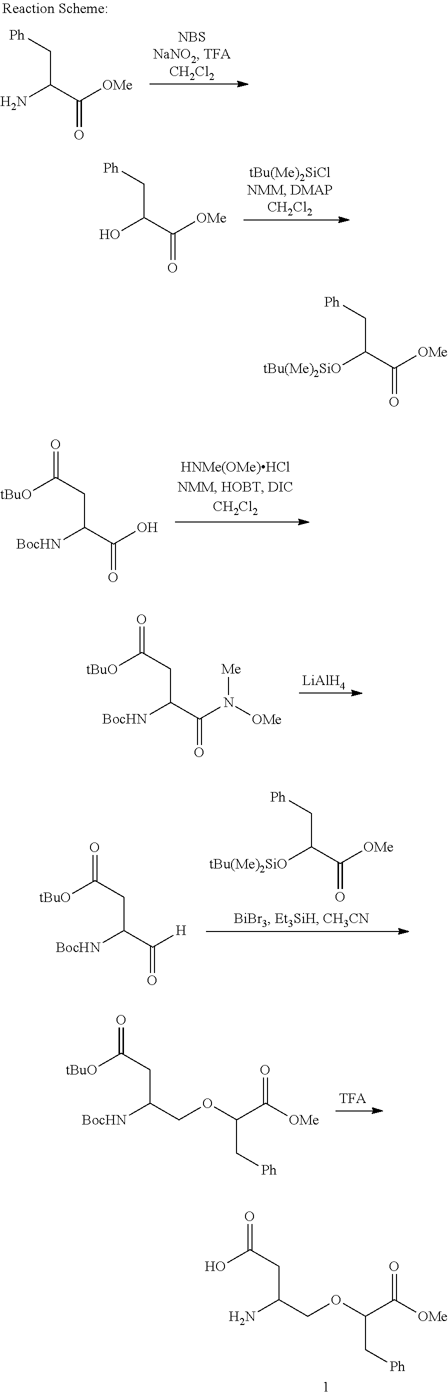

Compound 1 (“Naturlose”), the methyleneoxy ethoid of aspartame (asp-CH₂—O-phe), was prepared as follows. H-Phe-OMe was reacted with 2 equivalents of N-bromosuccinimide (NBS) in CH₂Cl₂ at room temperature for 5 minutes. To the mixture was added a solution of nitrous acid, prepared by slowly adding 5 equivalents of trifluoroacetic acid (TFA) to a stirred suspension of 5 equivalents NaNO₂ in CH₂Cl₂ (200 mM). After 10 minutes at room temperature gas evolution was finished and the reaction was concentrated in vacuo.

The residue was redissolved in ethyl acetate. The organic phase was washed with a 2 M HCl (3×), and brine (3×). The organic phase was dried (over Na₂SO₄), filtered, and concentrated in vacuo to give the α-hydroxy ester. The α-hydroxy ester was dissolved in CH₂Cl₂ and treated with 1.1 equivalents tert-butyldimethylchlorosilane (tBu(Me)₂SiCl), 0.5 equivalents N,N-dimethylaminopyridine (DMAP) and 1.1 equivalents N-methylmorpholine (NMM) for 1 hour at room temperature. The mixture was evaporated to give the silyl ether that was used without further purification.

Boc-Asp(OtBu)-OH was dissolved in CH₂Cl₂ (4 ml/mmol, if needed few drops of DMF were added to ensure total solubility). To the reaction vessel was added N,O-dimethylhydroxyl amine hydrochloride (1.1 eq), N-methylmorpholine (2.2 eq) (NMM) and N-hydroxybenzotriazole (1.1 eq) (HOBT). 1.1 equivalents diisopropylcarbodiimide (DIC) was then added slowly to the reaction mixture and was stirred overnight at room temperature. Completion of the reaction was confirmed by thin layer chromatography. The white urea precipitate was removed by filtration and the filtrate was washed with saturated NaHCO₃ (3 times), brine and 1 M HCl (3 times) and dried over Na₂SO₄. The solution was concentrated in vacuo to give the Weinreb amide. To a cooled solution of Weinreb amide in anhydrous tetrahydrofuran (5 ml/mmol) was added LiAlH₄ (5eq) as a solid. The reaction mixture was stirred 30 min at −70° C. The solution was diluted with diethyl ether and quenched with 1 M HCl (aq.). The aqueous layer was extracted with diethyl ether. The organic layer was then washed with saturated NaHCO₃, dried over Na₂SO₄ and then concentrated on a rotary evaporator to give Boc-Asp(OtBu)-H.

The silyl ether above (1.4 equivalents) was dissolved in anhydrous acetonitrile. To it was added 1.5 equivalents triethylsilane and 0.15 equivalents bismuth (III) bromide followed by 1 equivalents of Boc-Asp(OtBu)-H. The mixture was stirred at room temperature for 16 hours. The resulting reaction mixture was evaporated, redissolved in ethyl acetate and washed with 2M HCl (3×), and brine (3×). The organic phase was dried (Na₂SO₄), filtered, and concentrated in vacuo. The residue was treated with 1:1 mixture of trifluoroacetic acid (TFA)/CH₂Cl₂ for 45 minutes at room temperature and evaporated to provide crude compound 1 in approximately 57% yield (HPLC/MS).

Compound 1 was purified by RP-HPLC on a C₁₈ column with an acetonitrile/water solvent system.

### Example 2

### Synthesis of N—Ac-Phe-CH₂—O-Lys

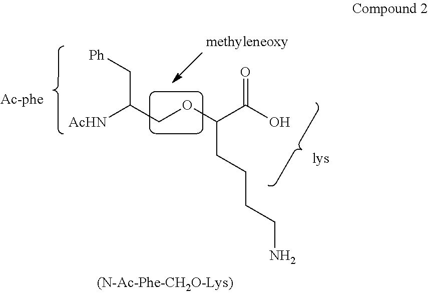

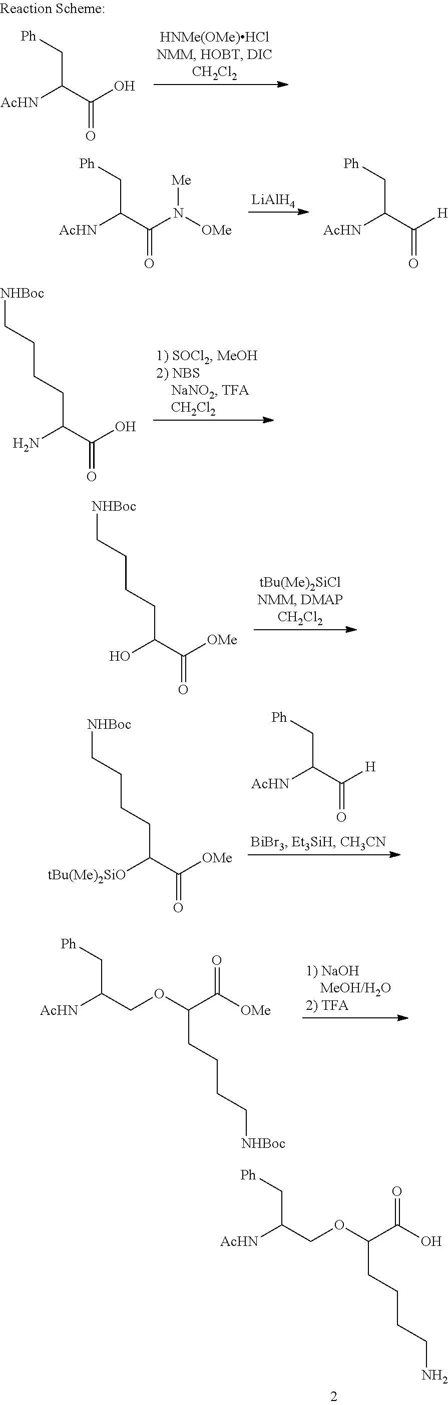

Compound 2 was prepared as follows. Ac-Phe-OH was dissolved in CH₂Cl₂ (4 ml/mmol, if needed few drops of DMF were added to ensure total solubility). To the reaction vessel was added N,O-dimethylhydroxyl amine hydrochloride (1.1 eq), N-methylmorpholine (2.2 eq) (NMM) and N-hydroxybenzotriazole (1.1 eq) (HOBT). 1.1 equivalents diisopropylcarbodiimide (DIC) was then added slowly to the reaction mixture which was stirred overnight at room temperature. Completion of the reaction was confirmed by thin layer chromatography.

The white urea precipitate was removed by filtration and the filtrate was washed with saturated NaHCO₃ (3 times), brine and 1 M HCl (3 times) and dried over Na₂SO₄. The solution was concentrated in vacuo to give the Weinreb amide. To a cooled solution of Weinreb amide in anhydrous tetrahydrofuran (5 ml/mmol) was added LiAlH₄ (5 eq) as a solid. The reaction mixture was stirred 30 min at −70° C. The solution was diluted with diethyl ether and quenched with 1M HCl (aq.). The aqueous layer was extracted with diethyl ether. The organic layer was then washed with saturated NaHCO₃, dried over Na₂SO₄ and then concentrated on a rotary evaporator to give Ac-Phe-H.

H-Lys(Boc)-OH was dissolved in dry methanol and treated slowly with 1 equivalent of thionyl chloride. The mixture was left to stand overnight at room temperature before being evaporated in vacuo. H-Lys(Boc)-OMe was reacted with 2 equivalents N-bromosuccinimide (NBS) in CH₂Cl₂ at room temperature for 5 minutes. To the mixture was added a solution of nitrous acid, prepared by slowly adding 5 equivalents of trifluoroacetic acid (TFA) to a stirred suspension of 5 equivalents NaNO₂ in CH₂Cl₂ (200 mM). After 10 minutes at room temperature gas evolution was finished and the reaction was concentrated in vacuo. The residue was redissolved in ethyl acetate. The organic phase was washed with a 2 M HCl (3×), and brine (3×). The organic phase was dried (Na₂SO₄), filtered, and concentrated in vacuo to give the α-hydroxy ester. The α-hydroxy ester was dissolved in CH₂Cl₂ and treated with 1.1 equivalents tert-butyldimethylchlorosilane (tBu(Me)₂SiCl), 0.5 equiv N,N-dimethylaminopyridine (DMAP) and 1.1 equivalents

N-methylmorpholine (NMM) for 1 hour at room temperature. The mixture was evaporated to give a silyl ether that was used without further purification.

The silyl ether (1.4 equivalents) was dissolved in anhydrous acetonitrile. To it was added 1.5 equivalents triethylsilane and 0.15 equivalents bismuth (III) bromide followed by 1 equivalents of Boc-Ac-Phe-H. The mixture was stirred at room temperature for 16 hours. The reaction was evaporated, redissolved in ethyl acetate and washed with 2M HCl (3×), and brine (3×). The organic phase was dried (Na₂SO₄), filtered, and concentrated in vacuo.

The residue was dissolved in methanol, cooled to 4° C. and treated with 2M NaOH (2 equivalents). The mixture was stirred at 4° C. for 4 hours and quenched with 2M HCl and evaporated. The residue was dissolved in ethyl acetate, and the organic layer washed with brine, dried (Na₂SO₄), filtered, and evaporated. The residue was treated with 1:1 mixture of trifluoroacetic acid (TFA)/CH₂Cl₂ for 45 minutes at room temperature and evaporated to give crude 2. Compound 2 was purified by RP-HPLC on a C₁₈ column with an acetonitrile/water solvent system.

### Example 3

### Sweetening Potency of Exemplary Ethoid Dipeptides

The sweetening potency of Compounds 1 and 2 was established by conducting blind taste tests of aqueous solutions of each of Compound 1 and 2 compared to aqueous solutions of each of sucrose and aspartame at concentrations of both 1 mg/ml and 5 mg/ml. Taste-test volunteers (six total) found both Compounds 1 and 2 significantly sweeter that the sucrose solution. Furthermore, Compound 1, the ethoid version of aspartame, was reported to be approximately 5 to 10 times sweeter than aspartame by the taste-test volunteers.

### Example 4

### Comparative Stability of Aspartame and Aspartame Ethoid in Solution

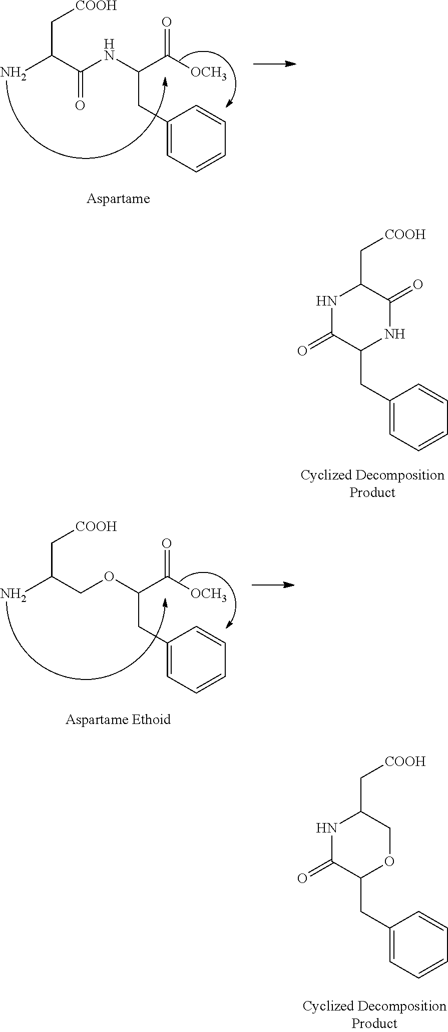

Solutions of Aspartame and Compound 1 were prepared by dissolving 10 mg of the subject dipeptide in 4 ml of PBS, pH=7.5. The two solutions were heated to 40° C. Aliquots (50 μl) were withdrawn at the following times: 0, 24 h, 36 h, 48 h and 60 h, and diluted with 125 μl of methanol/acetonitrile/0.1% TFA.

The samples were analyzed by HPLC-MS, using a Gilson HPLC with dual wavelengths UV detector (214 and 254 nm). The following conditions were employed: column: C18; 4.6×250 mm; 5 μmx 6A; solvent system: H₂O-1% TFA/Acetonitrile-1% TFA, 1 ml/min, with a gradient of 10% organic phase to 100% organic phase in 10 minutes, followed by a 10 minute hold at 100% of organic phase. As shown in the reaction schemes above, decomposition proceeds mainly via a cyclization reaction to form the corresponding cyclized product and methanol.

The AUC (at 214 nm) values corresponding to the dipeptide and corresponding cyclized products (aspartame→diketopiperazine and aspartame ethoid→ketooxazine) are summarized in the following Table.

| | |
|---|---|
| Aspartame | Ethoid compound |

| | | Cyclized | | Cyclized |
|---|---|---|---|---|
| Time (h) | SM (%) | product (%) | SM (%) | product (%) |
| 0 | 100 | 0 | 100 | 0 |
| 24 | 5 | 95 | 100 | 0 |
| 36 | 0 | 100 | 100 | 0 |
| 48 | 0 | 100 | 100 | 0 |
| 60 | 0 | 100 | 100 | 0 |

The foregoing data demonstrates the surprising stability of the aspartame ethoid against degradation when compared to unmodified aspartame. At 40° C., the ethoid exhibits a half-life in solution that is infinitely greater than that of aspartame—since under the conditions employed, essentially no degradation was observed! In light of these results, data was then collected under more stringent (i.e., higher) temperature conditions—to obtain a better indication of the comparative stability of the two compounds. Data collected at 65° C. indicates a half life of aspartame of 2.5 hours, while the half life of the corresponding methylene oxide ethoid is 305 hours—an improvement of over a hundred-fold! The stability of the ethoid against degradation is strikingly improved over aspartame—yet another unexpected advantage of the ethoid compounds described herein.

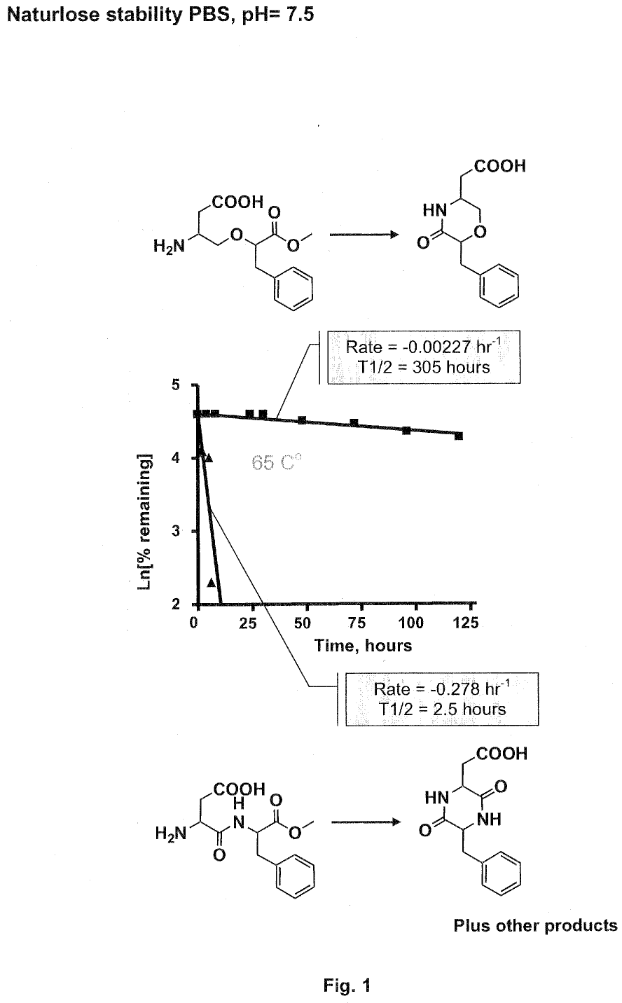

See, e.g., FIG. 1, which provides plots of the logarithm of percent of intact dipeptide remaining over time, in hours, for both aspartame and the methyleneoxy ethoid of aspartame. As can be seen, while the degradation of aspartame progresses rapidly under the pH and temperature conditions employed (e.g., degradation of aspartame is essentially complete at approximately 12 hours), degradation of the corresponding ethoid at the 12 hour time point is negligible. The rate of degradation of the methyleneoxy ethoid of aspartame is time, temperature, and pH dependent.

Moreover, the stability of the methyleneoxy ethoid of aspartame is significantly enhanced (over a hundred-fold) over that of the traditional peptide-linked aspartame.

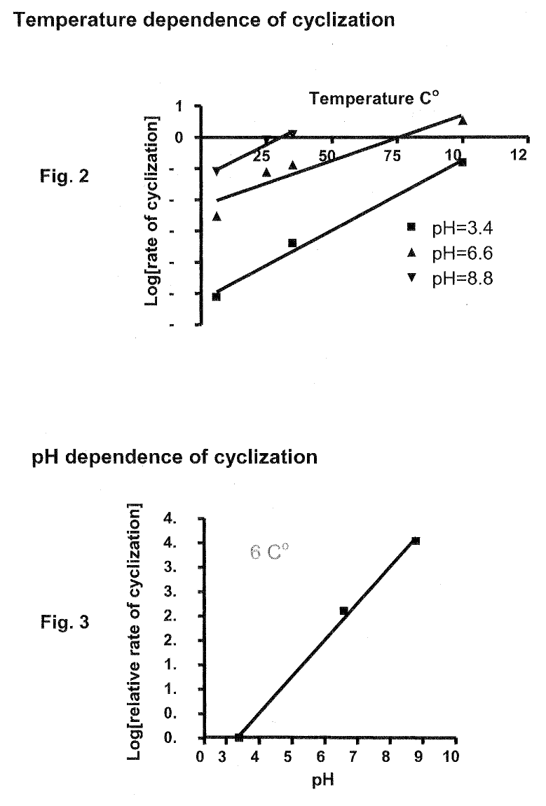

FIGS. 2 and 3 demonstrate the temperature and pH dependence, respectively, of the cyclization (decomposition) reaction of aspartame. The data shown graphically is based upon data described in Gaines, S. M.; Bada, J. L., J. Org. Chem., 53, 2757 and 2764 (1988)).

FIGS. 4A and 4b provide estimated stability profiles for the methyleneoxy ethoid of aspartame (FIG. 4A) and aspartame (FIG. 4B), respectively, as a function of temperature and pH. The estimated stability profiles were generated using calculated thermodynamic parameters.

Thus, the ethoid compounds described herein can provide the surprising advantage of enhanced stability when compared to conventional di-, or tri-peptides, oligopeptide compounds, and polypeptides. Moreover, their stability in solution at elevated temperatures, and at neutral pHs, as exemplified by the methyleneoxy ethoid of aspartame, provides a significant advantage over compounds such as aspartame.

### Example 5

### Synthesis of Methyleneoxy Ethoid of Aspartame (Compound 1)

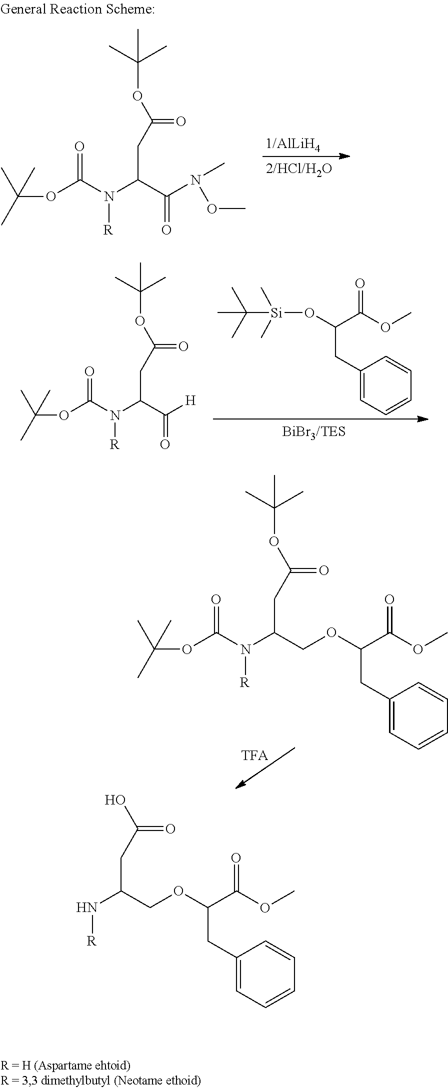

### Synthesis of Boc-Asp(OtBu)-N(OCH₃)CH₃

Boc-Asp(OtBu)-OH (1 eq) was dissolved in DCM. To the reaction vessel was added N,O-dimethylhydroxyl amine hydrochloride (1.1 eq), N-methylmorpholine (2.2 eq) and N-hydroxybenzotriazole (1.1 eq). DIC (1.1 eq) was then added to the reaction and stirred overnight at room temperature. Completion of the reaction was confirmed by TLC.

The white precipitate of DIU was removed by filtration and the filtrate was washed by 1 M HCl (3 times), brine and sat NaHCO₃ (3 times). The organic layer was separated and dried over Na₂SO₄. The solution was concentrated on a rotary evaporator to give the desired product.

### Synthesis of Boc-Asp(OtBu)-H

To a cooled solution (−70° C. in dry ice/acetone mixture) of Boc-Asp(OtBu)-N(OCH₃)CH₃ in THF (5 ml/mmol) was added LiAlH₄ (5 eq). The reaction mixture was stirred for 60 minutes, the reaction was diluted with DCM and quenched by addition of 1 M HCl at −70° C. The emulsion was extracted with DCM, and the organic layer was washed with sat NaHCO₃ (3 times), dried with Na₂SO₄ and concentrated on a rotary evaporator to give the aldehyde.

### Synthesis of HO-Phe-OMe

H-Phe-OH (1 eq) was dissolved in an aqueous solution of 0.5 M of H₂SO4 (2 eq), and cooled at 0° C. To this was added dropwise a 2M solution of sodium nitrite (4 eq); 4 hours later the reaction mixture was extracted by AcOEt (3 times), and the organic phase was dried and concentrated under reduced pressure. HO-PHE-OH was dissolved in MeOH, cooled to 0° C., to which was added 1.1 eq of thionyl chloride. After 12 hours the solvent was evaporated to give the desired product.

### Synthesis of terButyldimetylSilyl-O-Phe-Ome

To a solution of HO-Phe-OMe (1 eq) in DCM was added 2 eq of NMM, 1.2 eq of DMAP and 1.3 eq of tert-butyldimethylsilylchloride. The reaction was monitored by TLC. At completion, the organic phase was evaporated, the residue was redissolved in AcOEt, washed (3 times) with 1 M HCl, brine dried with Na₂SO₄ and concentrated on a rotary evaporator.

### Synthesis of Boc-Asp(OtBu)-O-Phe-OMe

To a solution of tert-butyldimethylsilyl-O-Phe-OMe (2 eq) in acetonitrile (and few drop of DCM to increase the solubility) was added with TES (3 eq) and BiBr3 (0.5 eq). After 5 minutes the reaction was cooled at 0° C. and a solution of Boc-Asp(OtBu)-H (1 eq) in acetonitrile was added dropwise. After 18 hrs the reaction was filtered over a silica plug. The filtrate was evaporated under reduced pressure and the residue obtained was then purified by HPLC.

The overall yield was 71% (HPLC/MS).

### Example 6

### Synthesis of Methyleneoxy Ethoid of Neotame (Compound 3)

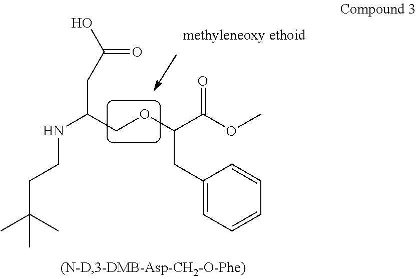

### Synthesis of Boc-N(3,3dimethylbutyl)Asp(OtBu)-OH

H-Asp(OtBu)-OH (prepared as described in Example 5 above) was dissolved in methanol, 3,3-dimethylbutyraldehyde (5 eq) and NaCNBH₄ (5 eq) were added and the reaction was stirred for 48 hrs. The reaction was dried under reduced pressure, and the residue obtained was redissolved in DMF, (2.2 eq) of Na₂CO₃, DMAP (0.1 eq) and Boc₂O (3 eq) were added and the reaction was refluxed 24 hr. The DMF was evaporated and the residue was dissolved in AcOEt, washed with 1 M HCl (3 times), dried and the solution was concentrated on a rotary evaporator to give the desired product. The product in purified on a silica column.

### Example 7

### Investigation of the Stability of the Methyleneoxy Ethoid of Neotame Relative to Neotame

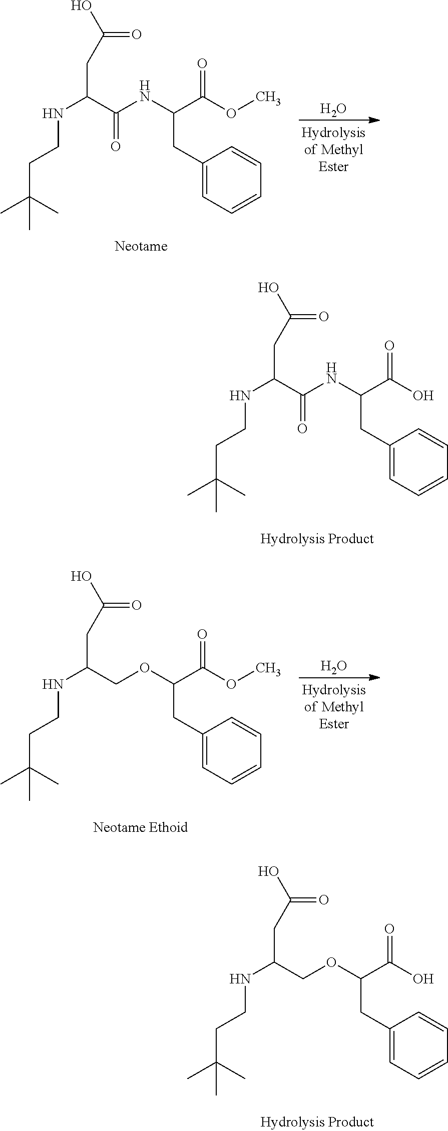

The solution stability of Compound 3 at various temperatures was examined and compared to that of neotame.

The major route leading to loss of neotame is hydrolysis of the methyl ester group as shown above. Degradation of neotame has been shown to be temperature dependent, with the overall kinetics being pseudo first order. The rates of degradation of neotame and the methyleneoxy ethoid of neotame were examined and compared. FIG. 5A demonstrates the rate of neotame degradation in solution at 90° C. FIG. 5B is a plot comparing the rate of degradation of neotame to that of the corresponding ethoid. As can be seen, the rates are nearly identical, with the ethoid demonstrating a stability profile similar to that of neotame. Because neotame is considered to possess an excellent stability profile (Neotame Stability Overview, 2001, NutraSweet Property Holdings, Published Jul. 1, 2002; Bulletin No. NTM, AU7), the temperature dependence exhibited by the ethoid is illustrative of yet another.

Other methods which were used but not described herein are well known and within the competence of one of ordinary skill in the art of chemistry, cell biology and molecular biology, microbiology, and clinical medicine.

The invention should not be construed to be limited solely to the assays and methods described herein, but should be construed to include other methods and assays as well. One of skill in the art will know that other assays and methods are available to perform the procedures described herein.

Headings are included herein for reference and to aid in locating certain sections. These headings are not intended to limit the scope of the concepts described therein under, and these concepts may have applicability in other sections throughout the entire specification.

The disclosures of each and every patent, patent application, and publication cited herein are hereby incorporated herein by reference in their entirety. While this invention has been disclosed with reference to specific embodiments, it is apparent that other embodiments and variations of this invention may be devised by the previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Accordingly, the present invention is not intended to be limited to the embodiments shown herein but is to be accorded the widest scope consistent with the principles and novel features disclosed herein.

1. A food product comprising a food ingredient, the food ingredient comprising a compound of Formula I-A 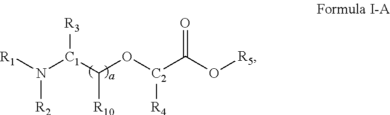
wherein
a is an integer ranging from 1 to 3, and
each R₁₀ is independently selected from the group consisting of H, halogen, hydroxy, C₁-C₃ alkyl and substituted C₁-C₃ alkyl,
R₁, R₂ and R₅ are each independently selected from the group consisting of hydrogen, alkyl, cycloalkyl, alkylene-cycloalkyl, alkyl-substituted cycloalkyl, aryl, alkylene-aryl, alkyl-substituted aryl, and acyl, each of the foregoing being optionally substituted with or one or more of halogen, hydroxyl, heteroatom, or heteroatom-containing groups, such heteroatom being selected from N and O, and
R₃ and R₄ are each independently selected from the group consisting of —CH₂C(O)OR₆, —CH₂C₆H₄R₆, and —(CH₂)₄NHR₆, wherein each R₆ is independently selected from hydrogen, methyl, ethyl or propyl.

2-175. (canceled)
